(19) United States
(12) Patent Application Publication
(10) Pub. No.: US 2026/0241285 A1
(43) Pub. Date: Aug. 20, 2026

(54) GAME SCENE GENERATION METHOD AND APPARATUS, STORAGE MEDIUM AND ELECTRONIC APPARATUS

(71) Applicant: NETEASE (HANGZHOU) NETWORK CO., LTD., Hangzhou (CN)

(72) Inventors: Jianlun TANG, Hangzhou (CN); Bai LI, Hangzhou (CN); Zhiyu CAO, Hangzhou (CN); Danfeng GE, Hangzhou (CN); Qing WANG, Hangzhou (CN)

(21) Appl. No.: 18/874,484

(22) PCT Filed: Oct. 26, 2022
(86) PCT No.: PCT/CN2022/127756

§ 371 Date: Dec. 12, 2024

(30) Foreign Application Priority Data
Jun. 15, 2022 (CN) 202210675156.4

(51) Int. Cl. A63F 13/56; A63F 13/50; A63F 13/822

(52) U.S. Cl. CPC A63F 13/56; A63F 13/50; A63F 13/822

(57) ABSTRACT

The present disclosure provides a game scene generating method, including: separately obtaining pathfinding graphs of a plurality of sub-virtual objects; determining a plurality of reference lines of the pathfinding graph of each sub-virtual object; determining at least one target geometric area in the pathfinding graph on the basis of the plurality of reference lines; and splicing the plurality of sub-virtual objects according to the at least one target geometric area corresponding to each sub-virtual object to obtain a game scene. A virtual game character performs pathfinding on the terrain of the game scene.

### CROSS-REFERENCE TO RELATED APPLICATIONS

The present disclosure is a 371 national phase application of PCT Application No. PCT/CN2022/127756 filed Oct. 26, 2022, which claims priority to Chinese patent application No. 202210675156.4, filed on Jun. 15, 2022, and entitled “GAME SCENE GENERATION METHOD AND APPARATUS, STORAGE MEDIUM AND ELECTRONIC APPARATUS”, the entire contents of both of which applications are hereby incorporated by reference for all purposes.

### TECHNICAL FIELD

The present disclosure relates to the field of games, and in particular to a game scene generation method and apparatus, a storage medium and an electronic apparatus.

### BACKGROUND

At present, game scenes are an important part of games, and the number and quality of game scenes will directly affect the game experience of players.

When a game scene is generated, the entire scene is divided into squares in advance, and then, a new game scene is generated by loading the squares into a specified position to ensure the randomness of generating a game scene in a game. However, this method only splices the scene resources of the game scene, but does not splice the terrain resources of the game scene, resulting in a virtual game character being unable to normally find a path in the generated game scene, thereby resulting in a technical problem that effective path finding cannot be ensured during generation of a game scene.

With regard to the above technical problem that effective path finding cannot be ensured during generation of a game scene, no effective solution has been proposed so far.

### SUMMARY

According to a first aspect, the present disclosure provides a game scene generation method, the method comprising: acquiring path finding maps of a plurality of sub-virtual objects, where the path finding map is used for guiding a virtual game character to find a path on a terrain of the corresponding sub-virtual object; determining a plurality of reference lines of the path finding map of each of the corresponding sub-virtual object, where the plurality of reference lines are used for enabling the virtual game character to find a path from the terrain of the corresponding sub-virtual object to a terrain of a sub-virtual object, other than the corresponding sub-virtual object within the plurality of sub-virtual objects; determining at least one target geometric area in the path finding map based on the plurality of reference lines; and splicing the plurality of sub-virtual objects according to the at least one target geometric area corresponding to each sub-virtual object to obtain a game scene, where the virtual game character finds a path on a terrain of the game scene.

According to a second aspect, the present disclosure provides one or more non-transitory computer-readable storage media containing, in any combination, computer program code that, when executed by a computer system, performs the operations in the above method for generating a new game scene.

According to a third aspect, the present disclosure provides a system, comprising one or more memories collectively containing one or more programs, and one or more processors, where the one or more processors are configured to, individually or collectively, perform the operations in the above method for generating a new game scene.

### BRIEF DESCRIPTION OF THE DRAWINGS

FIG. 1 is a hardware structure block diagram of a mobile terminal of a game scene generation method according to an embodiment of the present disclosure;

FIG. 2 is a flow chart of a game scene generation method according to an embodiment of the present disclosure;

FIG. 3 is a schematic diagram of determining a target square area according to an embodiment of the present disclosure;

FIG. 4 is a schematic diagram of a game scene formed by splicing island components according to an embodiment of the present disclosure;

FIG. 5 is a schematic diagram of an island tree according to an embodiment of the present disclosure;

FIG. 6 is a schematic diagram of a coordinate system of a three-dimensional scene according to an embodiment of the present disclosure;

FIG. 7 is a schematic diagram of an island component within an area expanded in positive directions of an x axis and a z axis according to an embodiment of the present disclosure;

FIG. 8A is a schematic diagram of the number of path finding map segments corresponding to a larger size lₜᵢₗₑ according to an embodiment of the present disclosure;

FIG. 8B is a schematic diagram of the number of path finding map segments corresponding to a smaller size lₜᵢₗₑ according to an embodiment of the present disclosure;

FIG. 9 is a schematic diagram of Tile areas in a path finding resource according to an embodiment of the present disclosure;

FIG. 10 is a schematic diagram of slots according to an embodiment of the present disclosure;

FIG. 11 is a schematic diagram of a square mesh according to an embodiment of the present disclosure;

FIG. 12 is a schematic diagram of a game scene generation apparatus according to an embodiment of the present disclosure; and

FIG. 13 is a schematic diagram of an electronic apparatus according to an embodiment of the present disclosure.

### DETAILED DESCRIPTION

In order to enable those skilled in the art to better understand the solutions in the present disclosure, the technical solutions in the embodiments of the present disclosure will be described clearly and completely below with reference to the accompanying drawings in the embodiments of the present disclosure. It is apparent that the described embodiments are only a part of the embodiments of the present disclosure, rather than all of the embodiments. All other embodiments obtained by those of ordinary skill in the art based on the embodiments in the present disclosure without any creative work should fall within the scope of protection of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

The terms such as “first”, “second”, and the like, as used in the specification, the claims of the present disclosure, and the above accompanying drawings are used to distinguish similar objects, but are not intended to describe a particular sequence or a precedence order. It is to be understood that the data used in this way can be interchanged under appropriate conditions, so that the embodiments of the present disclosure described herein can be implemented in a sequence other than those illustrated or described herein. In addition, the terms “include” and “have” and any variants thereof are intended to cover non-exclusive inclusion. For example, a process, method, system, product, or device that includes a series of steps or units is not necessarily limited to those steps or units that are clearly listed, but may include other steps or units not clearly listed or inherent to such process, method, product, or device. Additionally, depending on the context, the term “if” used herein may be explained as “when” or “while”, or “in response to . . . , it is determined that.”

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

In some embodiments of the present invention, path finding maps of multiple sub-virtual objects are respectively acquired, and multiple reference lines are determined within the path finding map of each sub-virtual object. Based on these reference lines, at least one target geometric area is determined in the path finding map, and the multiple sub-virtual objects are spliced according to the at least one target geometric area corresponding to each sub-virtual object to obtain a game scene. Through this approach, in some embodiments of the present invention, the target geometric area corresponding to each sub-virtual object is determined in the path finding map based on multiple reference lines of the path finding map of each sub-virtual object, and the multiple sub-virtual objects are then spliced according to the target geometric area to obtain a game scene. Moreover, the spliced path finding map remains effective in the game scene, thereby achieving the purpose of ensuring the normal operation of a terrain path finding system, and solving the technical problem of ineffective path finding during game scene generation.

First, some nouns or terms that appear in the process of describing the embodiments of the present disclosure are subject to the following explanations:

An island is a game scene formed by splicing multiple island components according to certain rules. Island components may include a main island, secondary islands, and connectors. An island may be formed by splicing a main island, multiple secondary islands, and multiple connectors.

Island components are scene art resources with the smallest granularity. Main island components and secondary island components in the island components may be spliced with connectors, and connectors may be spliced with main island components or secondary island components.

The main island component, i.e., the main island, may be a necessary component for forming a complete island. Moreover, in terms of quantity, a complete island may require one main island, and the main island has a relatively large size and a relatively complex terrain.

The connector may be an island component for connecting a main island and a secondary island, and each of the two ends of the connector has a slot.

The secondary island component, i.e., the secondary island, is the end of the island and can only define one slot for splicing with the connector, and the size thereof is relatively small.

The slot refers to a square area (Tile) covering an island component and is used for splicing island components. For example, there is a slot at each of two ends of a connector, and a slot on the flat terrain of the secondary island. If the slots between two island components are overlapped, the slots can be logically spliced together.

Transform is used in the game industry and three-dimensional scene design industry to describe the position and rotation of a three-dimensional object, and is a 4×3 matrix that is applicable to matrix operation rules. By using Transform to represent the position and rotation, a relative position and a world position can be calculated conveniently.

The coordinate system may be a coordinate system (x, y, z) for representing position relationships in a three-dimensional game scene.

According to one embodiment of the present disclosure, an embodiment of a game scene generation method is provided. It should be noted that the steps shown in the flow chart in the accompanying drawings may be executed in a computer system such as a set of computer executable instructions. Moreover, although a logical order is shown in the flow chart, in some embodiments, the steps shown or described may be executed in an order different from that shown here.

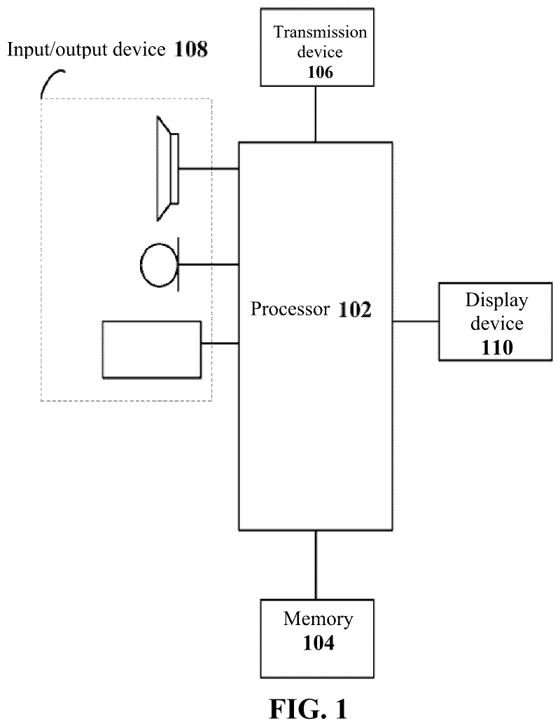

The method embodiment may be executed in a mobile terminal, a computer terminal, or a similar computing apparatus. Taking running on a mobile terminal as an example, the mobile terminal may be a smart phone (e.g., an Android phone or an iOS phone), a tablet computer, a handheld computer, a mobile Internet device (MID), a PAD, a game console, or other terminal devices. FIG. 1 is a hardware structure block diagram of a mobile terminal of a game scene generation method according to an embodiment of the present disclosure. As shown in FIG. 1, the mobile terminal may include one or more (only one is shown in FIG. 1) processors 102 (the processor 102 may include, but is not limited to, a central processing unit (CPU), a graphics processing unit (GPU), a digital signal processing (DSP) chip, a microprocessor (MCU), a field programmable gate array (FPGA), a neural network processor (NPU), a tensor processing unit (TPU), an artificial intelligence (AI) type processor, etc.), and a memory 104 for storing data. In some embodiments, the above mobile terminal may further include a transmission device 106, an input/output device 108, and a display device 110 for communication functions. Those of ordinary skill in the art can understand that the structure shown in FIG. 1 is merely illustrative and does not limit the structure of the above mobile terminal. For example, the mobile terminal may also include more or fewer components than those shown in FIG. 1, or have a configuration different from that shown in FIG. 1.

The memory 104 can be used for storing a computer program, for example, a software program and a module of application software, such as a computer program corresponding to the game scene generation method in the embodiments of the present disclosure. The processor 102 implements various functional applications and data processing by executing the computer program stored in the memory 104, thereby achieving the above game scene generation method. The memory 104 may include a high-speed random access memory, and may also include a non-volatile memory, such as one or more magnetic storage apparatuses, flash memories, or other non-volatile solid-state memories. In some examples, the memory 104 may further include memories remotely arranged relative to the processor 102, and these remote memories may be connected to the mobile terminal via a network. Examples of the above network include, but are not limited to, the Internet, an intranet, a local area network, a mobile communication network, and combinations thereof.

The transmission device 106 is configured to receive or send data via a network. The specific example of the above network may include a wireless network provided by a communication provider of the mobile terminal. In one example, the transmission device 106 includes a network interface controller (NIC) which can be connected to other network devices through a base station so as to communicate with the Internet. In one example, the transmission device 106 may be a radio frequency (RF) module which is configured to communicate with the Internet in a wireless mode.

The inputs in the input/output device 108 may come from multiple human interface devices (HIDs), for example, a keyboard and a mouse, a game handle, and other dedicated game controllers (e.g., a steering wheel, a fishing rod, a dancing blanket, and a remote controller). In addition to providing input functions, some human interface devices may also provide output functions, such as force feedback and vibration of a game handle, and audio output of a controller.

The display device 110 may be, for example, a head-up display (HUD), a touch-screen liquid crystal display (LCD), and a touch display (also referred to as a “touch screen” or a “touch display screen”). The liquid crystal display may enable a user to interact with a user interface of the mobile terminal. In some embodiments, the above mobile terminal has a graphical user interface (GUI), and a user can perform human-computer interaction with the GUI through finger contact and/or gestures on a touch-sensitive surface. The human-computer interaction functions here may include the following interactions: creating web pages, drawing, word processing, making electronic documents, games, video conferencing, instant messaging, receiving and sending emails, call interface, playing digital videos, playing digital music, and/or web browsing. Executable instructions for executing the above human-computer interaction functions are configured/stored in a computer program product or readable storage medium executable by one or more processors.

In some embodiments of the present disclosure, a game scene generation method may be executed on a local terminal device or a server. When the game scene generation method is executed on a server, the method may be implemented and executed based on a cloud interaction system, where the cloud interaction system includes a server and a client device.

In some embodiments of the present disclosure, various cloud applications, such as cloud games, can be executed under the cloud interaction system. Taking a cloud game as an example, the cloud game refers to a game mode based on cloud computing. In a cloud game operation mode, a game program executing entity and a game screen presenting entity are separated. The storage and execution of the game scene generation method are completed on a cloud game server. A client device is used for receiving and sending data and presenting a game screen. For example, the client device may be a display device with a data transmission function close to a user side, such as a mobile terminal, a television, a computer, or a handheld computer, but a cloud game server at the cloud terminal is responsible for information processing. When playing a game, a player operates a client device to send operation instructions to the cloud game server, the cloud game server executes the game according to the operation instructions, encodes and compresses the game screen and other data and returns the game screen to the client device through the network, and finally, the client device decodes and outputs the game screen.

In some embodiments of the present disclosure, taking a game as an example, the local terminal device stores a game program and is configured to present a game screen. The local terminal device is configured to interact with the player through the graphical user interface, to download and install the game program and execute the game program in a conventional mode through an electronic apparatus. The local terminal device may provide the graphical user interface to the player in a variety of ways, for example, by rendering and displaying the graphical user interface on the display screen of the terminal, or by providing the graphical user interface to the player through holographic projection. For example, the local terminal device may include a display screen and a processor. The display screen is configured to present a graphical user interface, and the graphical user interface includes a game screen. The processor is configured to execute the game, generate the graphical user interface, and control the display of the graphical user interface on the display screen.

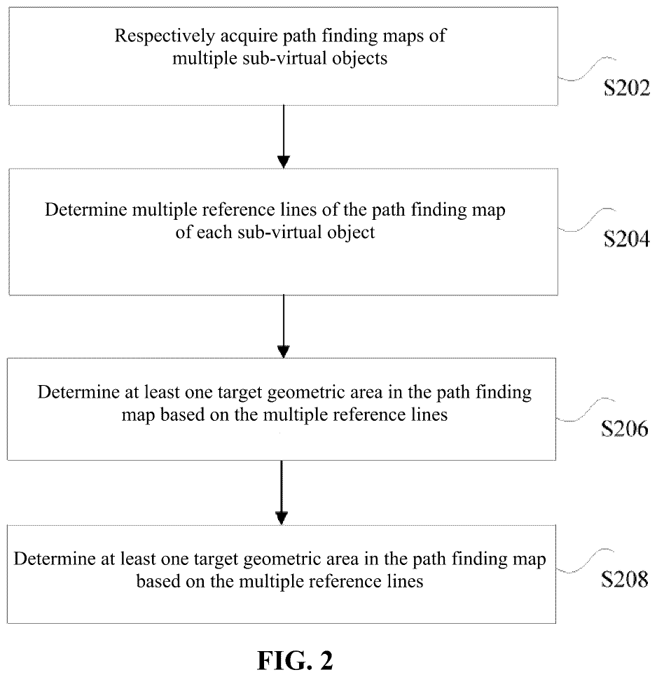

In some embodiments of the present disclosure, a game scene generation method is provided, which offers a graphical user interface through a terminal device, where the terminal device may be the local terminal device mentioned above, or may be the client device in the cloud interaction system mentioned above. FIG. 2 is a flow chart of a game scene generation method according to an embodiment of the present disclosure. As shown in FIG. 2, the method may include the following steps:

Step S202: Path finding maps of multiple sub-virtual objects are respectively acquired.

In the technical solution provided in the above step S202 of the present disclosure, the path finding maps of the multiple sub-virtual objects may be respectively acquired according to path finding resources of the multiple sub-virtual objects, where the sub-virtual objects may be terrain components that need to be spliced, such as a main island, a secondary island and a connector in island components, and the path finding map can be used for guiding the virtual game character to find a path on the terrain of the corresponding sub-virtual object, so the path finding map is strongly correlated with the terrain of the sub-virtual object, and the virtual game character may be a virtual character in the game scene.

In some embodiments of the present disclosure, the path finding map may be a path finding mesh (NavMesh). The path finding mesh is a polygonal mesh composed of polygons. The path finding mesh is divided into squares, and each small square area obtained can be called a square (Tile) area, or a Tile mesh. In other words, the small square area may be a path finding tile. For example, the path finding map is generated by path finding resources of island components. The path finding map is a polygonal mesh. The path finding map is divided into squares, and each square area obtained is a path finding tile (Tile area) which is a square area on the island component.

In some embodiments of the present disclosure, a complete sub-virtual object may include terrain resources and path finding resources, where the terrain resources are used for representing the scene terrain style and may be referred to as scene terrain resources or terrain model resources; and the path finding resources may correspond to the terrain resources and are generated by an editor according to the terrain resources of the sub-virtual object, which may abstract a game scene into a specific mathematical model for representing the scene structure of the game scene, obstacle information, walkable area information, etc. It should be noted that the above terrain resources may be spliced arbitrarily, but the path finding resources need to be spliced based on Tile.

In some embodiments of the present disclosure, the path finding resources of the sub-virtual object are spliced based on Tile. The Tile function in a game engine can be used for dividing the path finding map of the sub-virtual object in the game scene into squares to obtain multiple Tile areas, and these Tile areas are saved. When entering the game scene actually, the positions and orientations of multiple sub-virtual objects are randomly generated. Therefore, when a new path finding map is loaded, the previously stored Tile areas need to be spliced in pre-calculated positions to achieve the purpose of ensuring the diversity of the game scene while ensuring the normal operation of a path finding system.

In some embodiments of the present disclosure, the path finding map of each sub-virtual object may include multiple path finding files, the number of the path finding files may be the same as the number of Tile areas divided in the sub-virtual object, and both have a one-to-one correspondence relationship. For example, the path finding NavMesh of each island component is generated according to the Tile area division, and the path finding map produced by each island component involves multiple path finding files. The number of the path finding files is the same as the number of Tile areas divided in the island component, and both have a one-to-one correspondence relationship.

In some embodiments of the present disclosure, multiple sub-virtual objects may be pre-made by an editor, where the editor may be a scene designer or a scene editor, which is not specifically limited here.

Step S204: Multiple reference lines of the path finding map of each sub-virtual object are determined.

In the technical solution provided in the above step S204 of the present disclosure, the path finding map of each sub-virtual object has multiple reference lines, and the multiple reference lines of the path finding map of each sub-virtual object are determined respectively, where the reference line may be a line determined at every mesh size along the direction of two mutually perpendicular coordinate axes with the terrain origin of each sub-virtual object as the origin.

In some embodiments of the present disclosure, the reference lines may be used for representing a pre-set constraint condition for splicing the path finding map of each sub-virtual object, such as splicing only the path finding map that needs to be spliced according to the Tile areas determined by the reference lines.

Step S206: At least one target geometric area is determined in the path finding map based on the multiple reference lines.

In the technical solution provided in the above step S206 of the present disclosure, multiple target geometric areas may be determined according to the multiple reference lines of the path finding map of each sub-virtual object, and at least one of the multiple target geometric areas may be spliced with the target geometric areas of the path finding maps of other sub-virtual objects, where the target geometric area may be a slot of the sub-virtual object, and the slot may be a square mesh at the edge of the path finding map of the sub-virtual object, which is the above-mentioned Tile area.

In some embodiments of the present disclosure, since at least one of the multiple target geometric areas of a sub-virtual object may be spliced with the target geometric areas of the path finding maps of other sub-virtual objects, the sub-virtual object may be reused, the total amount of art resources and the workload of artists can be reduced.

Step S208: The multiple sub-virtual objects are spliced according to the at least one target geometric area corresponding to each sub-virtual object to obtain a game scene.

In the technical solution provided in the above step S208 of the present disclosure, each sub-virtual object has corresponding multiple target geometric areas, the geometric areas corresponding to multiple sub-virtual objects that can be matched are spliced to obtain a game scene, and the virtual game character can find a path on the terrain of the game scene.

In some embodiments of the present disclosure, such as when multiple sub-virtual objects are spliced, if the target geometric areas of the sub-virtual objects can be directly overlapped, the splicing between the path finding maps of the multiple sub-virtual objects can be achieved. If the target geometric areas of the sub-virtual objects cannot be directly overlapped, the sub-virtual objects can be rotated and translated until the target geometric areas of the multiple sub-virtual objects are overlapped, so as to achieve the splicing between the path finding maps of the multiple sub-virtual objects. Since the splicing between the path finding maps is based on a square mesh, when the sub-virtual object is rotated, the rotation angle may be an integer multiple of 90°; and when the sub-virtual object is translated, the translation amount may be an integer multiple of the side length of the square area.

In some embodiments of the present disclosure, the game scene is obtained by splicing multiple sub-virtual objects, so that each time a player enters the game application, the generated game scene may be different according to different splicing modes. For example, in an island scene, due to the differences in splicing modes of a main island, secondary islands and connectors in island components, the position, distribution and shape of the generated island will also be different, and the obtained game scene may also be different, thereby achieving the purpose of creating randomness of game scenes.

It should be noted that the above sub-virtual objects in this embodiment may be island components, dungeon components, maze components, etc., and no specific limitation is made here.

In this embodiment, the generation of the game scene can be analyzed from the whole to the part or from the part to the whole, and the game scene can be generated by splicing sub-virtual objects. In the analysis solution from the whole to the part, in response to the input operation instructions acting on the graphical user interface, each sub-virtual object in the game scene to be generated can be analyzed, and the entire game scene can be logically split into multiple sub-virtual objects. For example, the game scene to be generated may be an island community scene, each island in the island community scene is analyzed, and each island is logically split into one main island, several connectors, and several secondary islands. Final island components are determined according to the island components obtained by analysis. In the analysis solution from the part to the whole, in response to the input operation instructions acting on the graphical user interface, the type, number and pattern of each sub-virtual object can be predetermined according to the design style of the game scene to be generated, and thus, various sub-virtual objects can be made. Then, according to the size and style of the overall game scene, the sub-virtual objects are spliced to obtain a final game scene. For example, according to the design style of an island community scene, the type, number and pattern of each island component need to be predetermined, and thus, various types of island components can be made. Then, according to the size and style of the overall island community, the island components are spliced to obtain a final island community.

It should be noted that no matter which of the above analysis solutions is adopted in this embodiment, it is necessary to output each sub-virtual object according to certain specifications, so as to define the target area for splicing on each sub-virtual object. For example, slots of each island component are defined to achieve the splicing of each sub-virtual object, reduce the workload and resources of art, and also output game scenes with rich shapes.

In some embodiments of the present disclosure, such as when multiple sub-virtual objects are spliced, it is necessary to first splice the path finding maps of the sub-virtual objects, and then determine the position of an actual terrain to ensure that the spliced path finding map and the terrain still have a strong correlation, and the spliced path finding map and the terrain are still closely fitted.

In this embodiment, a walkable, efficient, and low-workload game scene output process is particularly important. The game scene of this embodiment may be a large-scale game scene that meets certain constraint conditions. In some embodiments, such as when the first sub-virtual object is an island component, the above game scene may be a vast sea with multiple islands, and the multiple islands may be random irregular island communities. In this embodiment, the game scene may be an island community scene, where the random irregularity may refer to the diversity of multiple islands within a certain range, thereby ensuring the diversity of game scenes.

Through the above steps S202 to S208 in the present disclosure, path finding maps of multiple sub-virtual objects are respectively acquired; multiple reference lines of the path finding map of each sub-virtual object are determined; at least one target geometric area is determined in the path finding map based on the multiple reference lines; and the multiple sub-virtual objects are spliced according to the at least one target geometric area corresponding to each sub-virtual object to obtain a game scene. In some embodiments of the present disclosure, the target geometric area corresponding to each sub-virtual object is determined in the path finding map based on multiple reference lines of the path finding map of each sub-virtual object, and then, multiple sub-virtual objects are spliced according to the matched target geometric area to obtain a game scene. In this game scene, the spliced path finding map is still effective, thereby achieving the purpose of ensuring the normal operation of a terrain path finding system, and solving the technical problem that effective path finding cannot be ensured during generation of a game scene.

The above method of this embodiment is further introduced below.

In some embodiments of the present disclosure, at step S204, the process of determining multiple reference lines of the path finding map of each sub-virtual object includes: the multiple reference lines are determined based on a local coordinate system where the path finding map is located.

In this embodiment, multiple reference lines of the path finding map of the sub-virtual object may be determined by the local coordinate system where the path finding map of the sub-virtual object is located, where the local coordinate system may be a partial coordinate system where the path finding map of the sub-virtual object is located in the entire path finding map coordinate system of the game scene.

In some embodiments of the present disclosure, the path finding map of the sub-virtual object can be viewed in the negative direction of the y axis in the three-dimensional coordinate system, and the area expanded in the positive direction of the x axis and the positive direction of the z axis can be determined as the local coordinate system where the path finding map of the sub-virtual object is located.

In some embodiments of the present disclosure, the process of determining the multiple reference lines based on a local coordinate system where the path finding map is located includes: the origin of the coordinate system is taken as a reference, a reference line perpendicular to a first coordinate axis is determined at intervals of a target size along the first coordinate axis of the coordinate system, and a reference line perpendicular to a second coordinate axis is determined at intervals of the target size along the second coordinate axis of the coordinate system, so as to obtain the multiple reference lines, where the first coordinate axis and the second coordinate axis are perpendicular to each other.

In this embodiment, the origin of the local coordinate system where the path finding map of the sub-virtual object is located is taken as a reference, a reference line perpendicular to a first coordinate axis is determined at intervals of a target size along the first coordinate axis of the local coordinate system, and a reference line perpendicular to a second coordinate axis is determined at intervals of the target size along the second coordinate axis of the coordinate system, so as to obtain the multiple reference lines. The area defined by the reference line perpendicular to the first coordinate axis and the reference line perpendicular to the second coordinate axis may be the target geometric area of the sub-virtual object, where the first coordinate axis may be the x axis in the three-dimensional coordinate system, the first coordinate axis may be the z axis in the three-dimensional coordinate system, and the target size may be the Tile mesh size (lₜᵢₗₑ) on the path finding map, such as the side length of the Tile mesh.

In some embodiments of the present disclosure, the origin of the local coordinate system where the path finding map of the sub-virtual object is located may be the coordinate origin of the coordinate system where the entire path finding map is located in the game scene, or may be the coordinate origin reset in the local coordinate system where the path finding map of the sub-virtual object is located. The coordinate origin may be represented as (0, 0, 0), which is not specifically limited here.

In some embodiments of the present disclosure, the target size is negatively correlated with the accuracy of splicing the multiple sub-virtual objects.

In this embodiment, the selection of the target size will affect the accuracy of splicing the multiple sub-virtual objects. The target size is negatively correlated with the accuracy of splicing the multiple sub-virtual objects. The larger the target size, the lower the splicing accuracy, where the splicing accuracy may be path finding accuracy.

In some embodiments of the present disclosure, the smaller the target size, the more path finding resource files are required, and the higher the accuracy of splicing the multiple sub-virtual objects is; and the larger the target size, the fewer the path finding resource files are required, and the lower the accuracy of splicing the multiple sub-virtual objects is.

In some embodiments of the present disclosure, the actual value of the target size may be an empirical value determined according to project conditions, which is not specifically limited here.

In some embodiments of the present disclosure, the origin of the local coordinate system where the terrain of each sub-virtual object is located is determined as the origin of the coordinate system where the path finding map is located.

In this embodiment, the path finding map of each sub-virtual object is strongly correlated with the terrain of each sub-virtual object, and the geometric shapes of the terrain and the path finding map are almost the same. Therefore, the origin of the local coordinate system where the terrain of each sub-virtual object is located may also be determined as the origin of the coordinate system where the path finding map is located, where the local coordinate system where the terrain of the sub-virtual object is located may be a partial coordinate system where the terrain of the sub-virtual object is located in the entire terrain coordinate system of the game scene.

In some embodiments of the present disclosure, the origin of the local coordinate system where the terrain of the sub-virtual object is located may be the coordinate origin of the coordinate system where the entire terrain is located in the game scene, or may be the coordinate origin reset in the local coordinate system where the terrain of the sub-virtual object is located. The coordinate origin may be represented as (0, 0, 0), which is not specifically limited here.

In some embodiments of the present disclosure, at step S206, the process of determining at least one target geometric area in the path finding map based on the multiple reference lines includes: the path finding map is divided into multiple square areas based on the multiple reference lines; and at least one target square area is determined in the multiple square areas, where the at least one target geometric area includes the at least one target square area.

In this embodiment, the path finding maps of the multiple sub-virtual objects may be spliced through a target geometric area. A target geometric area includes at least one target square area. Multiple reference lines perpendicular to the first coordinate axis and multiple reference lines perpendicular to the second coordinate axis may divide the path finding map of the sub-virtual object into multiple square areas, and the target square area is determined in the multiple square areas. The target square area may be a reference line mesh for splicing the path finding maps of the multiple sub-virtual objects.

In some embodiments of the present disclosure, the process of determining at least one target square area in the multiple square areas includes: at least one square area located at an edge position of each corresponding sub-virtual object in the multiple square areas is determined as the at least one target square area.

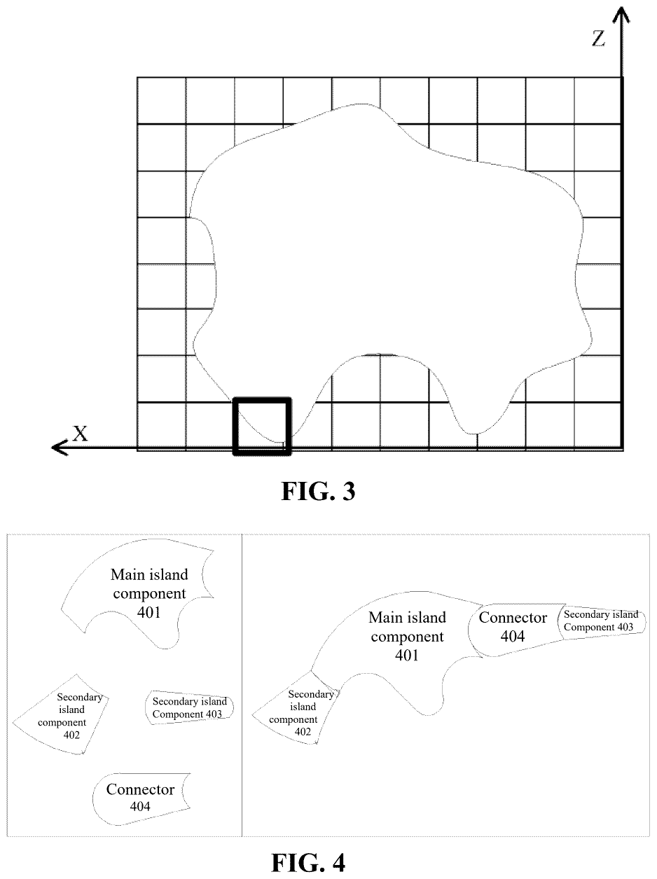

In this embodiment, the path finding map of the sub-virtual object is divided into multiple square areas. In the multiple square areas, the square area at the edge position of each sub-virtual object may be determined as the target square area. FIG. 3 is a schematic diagram of determining a target square area according to an embodiment of the present disclosure. As shown in FIG. 3, the path finding map of the sub-virtual object can be divided into multiple square areas by using multiple reference lines perpendicular to the x axis and multiple reference lines perpendicular to the z axis. As shown in the black square block in the figure, the square area at the edge position of the sub-virtual object is determined as the target square area.

It should be noted that an actual sub-virtual object may be represented as an irregular image in the coordinate system, and the edge of the path finding map of the sub-virtual object is not necessarily a square area.

In some embodiments of the present disclosure, at step S208, the process of splicing the multiple sub-virtual objects according to the at least one target geometric area corresponding to each sub-virtual object to obtain a game scene includes: the corresponding at least one target geometric area in the path finding map of a first sub-virtual object is overlapped with the corresponding at least one target geometric area in the path finding map of a second sub-virtual object based on the association relationship between the first sub-virtual object and the second sub-virtual object to obtain the game scene, where the first sub-virtual object and the second sub-virtual object are any two sub-virtual objects in the multiple sub-virtual objects, and the association relationship is used for indicating that the virtual game character is allowed to find a path between the terrain of the first sub-virtual object and the terrain of the second sub-virtual object.

In this embodiment, association information between the first sub-virtual object and the second sub-virtual object is acquired, and the corresponding at least one target geometric area in the path finding map of the first sub-virtual object is overlapped with the corresponding at least one target geometric area in the path finding map of the second sub-virtual object according to the association information to obtain the game scene, where the association information may be used for representing the connection relationship between the target geometric areas in the path finding map of the sub-virtual object during splicing, the first sub-virtual object may be one of the sub-virtual objects that need to be spliced, the second sub-virtual object may be another sub-virtual object that needs to be spliced, and the target area may be an area for achieving the splicing of the two sub-virtual objects.

For example, a target geometric area is determined on a main island path finding map in island components, a target geometric area is determined on a secondary island path finding map in the island components, and then, the association information may be used for representing the connection relationship between the main island path finding map and the secondary island path finding map. The target geometric area on the main island path finding map and the target geometric area on the secondary island path finding map are overlapped, so that a game scene in which the main island and the secondary island are spliced together can be achieved, and the virtual game character can find a path on the terrain of the game scene.

In some embodiments of the present disclosure, the main island and the secondary island in the island components may also be connected through a connector component, and then, the association information may be used for representing the connection relationship between the main island path finding map as well as the secondary island path finding map and a connector path finding map respectively (main island+connector+secondary island). On the connector component path finding map, a target geometric area spliced with the target geometric area on the main island path finding map and a target geometric area spliced with the target geometric area on the secondary island path finding map are determined respectively. By splicing the main island and the secondary island through the two target geometric areas of the connector component, a game scene in which the main island and the secondary island are spliced together can be achieved.

In some embodiments of the present disclosure, only one target geometric area spliced with the target geometric area on the main island path finding map may be determined on the connector component path finding map, and then, the association information may be used for representing the connection relationship between the main island path finding map and the connector path finding map. By splicing the connector component with the main island, a game scene of a broken bridge can be achieved.

In some embodiments of the present disclosure, such as when multiple sub-virtual objects are spliced based on the association relationship to obtain a game scene, the splicing order of the multiple sub-virtual objects can be determined based on an object tree. The splicing order can be used for representing the connection order of the multiple sub-virtual objects during splicing, so as to splice the multiple sub-virtual objects to obtain a game scene. For example, if the sub-virtual object is an island component, the splicing order can be the order of main island+connector+secondary island. Thus, the main island and the connector can be spliced first according to this order, and after the position of the connector is determined, the secondary island can be spliced to the connector.

It should be noted that the above splicing order of main island+connector+secondary island is only an example of the embodiments of the present disclosure, and the splicing order of the embodiments of this application is not limited to the above splicing order only. For example, the main island and the secondary island are directly connected, and the end of the connector is not connected to the secondary island, for example, a broken bridge on the island needs to be made. Any order that can be used for achieving the splicing of multiple sub-virtual objects is within the scope of the embodiments of this application, and will not be illustrated one by one here.

In some embodiments of the present disclosure, the process of overlapping the corresponding at least one target geometric area in the path finding map of a first sub-virtual object with the corresponding at least one target geometric area in the path finding map of a second sub-virtual object to obtain the game scene includes: at least one first sub-path finding map on the corresponding at least one target geometric area is determined in the path finding map of the first sub-virtual object; at least one second sub-path finding map on the corresponding at least one target geometric area is determined in the path finding map of the second sub-virtual object; the at least one first sub-path finding map is overlapped with the at least one second sub-path finding map to obtain a target path finding map, where the path finding map is located within an area defined by the multiple reference lines; and the game scene is generated based on the target path finding map.

In this embodiment, in the path finding map of the first sub-virtual object, the first sub-path finding map on the target geometric area is determined; in the path finding map of the second sub-virtual object, the second sub-path finding map on the target geometric area is determined; and the first sub-path finding map is overlapped with the second sub-path finding map to obtain a target path finding map, and a game scene is generated based on the target path finding map. The first sub-path finding map may be a path finding mesh (NavMesh) for scene path finding corresponding to each mesh on the target geometric area in the path finding map of the first sub-virtual object. The second sub-path finding map may be a NavMesh for scene path finding corresponding to each mesh on the target geometric area in the path finding map of the second sub-virtual object. The target path finding map may be a path finding map on the target geometric area spliced by the first sub-virtual object and the second sub-virtual object.

In some embodiments of the present disclosure, in the game scene generated based on the target path finding map, path finding maps of multiple sub-virtual objects can be spliced, thereby achieving the purpose of ensuring the normal operation of a path finding system when the game scene changes.

In some embodiments of the present disclosure, at step S208, orientation adjustment information of the second sub-virtual object in the world space is determined based on a first current orientation in the world space of the corresponding at least one target geometric area in the path finding map of the first sub-virtual object and a second current orientation in the world space of the corresponding at least one target geometric area in the path finding map of the second sub-virtual object, where the first current orientation and the second current orientation are randomly determined orientations, and the orientation adjustment information is used for representing information for adjusting the position of the second sub-virtual object in the world space and/or information for adjusting the direction of the second sub-virtual object in the world space; and the current orientation of the second sub-virtual object in the world space is adjusted based on the orientation adjustment information so that the corresponding at least one target geometric area in the path finding map of the first sub-virtual object is overlapped with the corresponding at least one target geometric area in the path finding map of the adjusted second sub-virtual object.

In this embodiment, the splicing of multiple sub-virtual objects can be achieved based on the Transform of each sub-virtual object in the world space, based on the first current orientation of the target geometric area in the path finding map of the first sub-virtual object in the world space and the second current orientation of the target geometric area in the path finding map of the second sub-virtual object in the world space, the orientation adjustment information of the second sub-virtual object in the world space can be determined, and the current orientation of the second sub-virtual object in the world space is adjusted according to the orientation adjustment information, so that the target geometric area corresponding to the path finding map of the first sub-virtual object is overlapped with the target geometric area corresponding to the path finding map of the adjusted second sub-virtual object, where the first current orientation may be the position information of the target geometric area in the path finding map of the first sub-virtual object in the world space, the second current orientation may be the position information of the target geometric area in the path finding map of the second sub-virtual object in the world space, and the orientation adjustment information may be the information for indicating that the current position or direction of the target geometric area in the path finding map of the second sub-virtual object in the world space needs to be adjusted, such as translation or rotation.

In some embodiments of the present disclosure, such as when the target areas in the path finding maps on every two adjacent sub-virtual objects are overlapped, it is necessary to comply with the splicing scale of the target areas. For example, when island components are spliced, it is necessary to comply with the splicing scale of polygonal meshes and align terrain meshes. For translation, the translation amount is an integer multiple of the side length of the square, so the x and z direction values of the translation can only be integer multiples of the side length of the terrain mesh. Since the target area is a square area, according to the rotation invariance thereof, the rotation of two sub-virtual objects may be an integer multiple of 90°, theoretically supporting splicing in four directions.

For example, the first sub-virtual object is a main island component. Based on the position of the main island component, connectors and secondary island components are spliced onto the main island, and then, the second sub-virtual objects may be the connectors and the secondary island components. During splicing, each island component needs to be rotated and translated to an appropriate position to complete the splicing, and the connectors and the secondary island components are translated and rotated until they are successfully connected to the main island component.

In some embodiments of the present disclosure, this system may not consider the translation and rotation of a sub-virtual object first, and may determine the translation and rotation of other sub-virtual objects after splicing, and then rotate and translate the spliced sub-virtual object as a whole based on the translation and rotation of the above sub-virtual object. The corresponding relationship between the sub-virtual objects may be defined through a configuration table.

For example, the sub-virtual object is an island component. Based on the position ofa main island component, connectors and secondary island components are spliced onto the main island component. During splicing, each island component needs to be rotated and translated to an appropriate position to complete the splicing. This process may not consider the translation and rotation of the main island component first, calculate the translation and rotation of each of the connectors and secondary island components after splicing, and then rotate and translate the entire spliced island based on the translation and rotation of the main island component. The corresponding relationship among the slots of each connector, each secondary island component and the main island component can be defined through a configuration table.

In some embodiments of the present disclosure, an editor can make a selection in an island component library to procedurally generate a required first target virtual object by a configuration table, for example, generate a required island.

In some embodiments of the present disclosure, at step S208, the first sub-virtual object and the second sub-virtual object and the association relationship are read in a configuration relationship table, where the configuration relationship table includes identifiers of the multiple sub-virtual objects, and includes an association relationship between every two sub-virtual objects in the multiple sub-virtual objects, and the association relationship between every two sub-virtual objects is used for indicating that the virtual game character is allowed to find a path between the terrains of the every two sub-virtual objects.

In this embodiment, the configuration relationship table may include identifiers of the multiple sub-virtual objects and an association relationship between every two sub-virtual objects in the multiple sub-virtual objects. Before the sub-virtual objects are spliced, the first sub-virtual object and the second sub-virtual object and the association relationship between the first sub-virtual object and the second sub-virtual object may be read in the configuration relationship table, where the identifiers of the sub-virtual objects and the association relationship between every two sub-virtual objects in the sub-virtual objects may be used for representing attribute information of the sub-virtual objects, and the attribute information may include information of the corresponding sub-virtual objects themselves, for example, the type of the sub-virtual object, the position of the sub-virtual object, and a target area for splicing the sub-virtual objects. In order to limit the complexity of splicing, the type of the sub-virtual object may be defined, for example, a main island component, a secondary island component, and a connector.

In some embodiments of the present disclosure, the attribute information may also include information about other sub-virtual objects that are allowed to be spliced with the sub-virtual object. For example, the attribute information may include which sub-virtual object the sub-virtual object corresponds to, and which sub-virtual object is used for connection. For example, when the sub-virtual object is a main island component, the attribute information of the main island component may include information about a connector that is allowed to be spliced with the main island component. For another example, when the sub-virtual object is a connector, the attribute information of the connector may include information about a secondary island component that is allowed to be spliced with the connector.

In some embodiments of the present disclosure, the attribute information may also include the number of sub-virtual objects of the same type.

In some embodiments of the present disclosure, the configuration relationship table can be customized by a game project, and the main function thereof is to provide sub-virtual object splicing information. For example, if the sub-virtual object is a main island component, the configuration relationship table can provide the position of the main island component. If there are multiple slots on the main island component, the configuration relationship table can also provide which secondary island component each slot corresponds to and which connector to use. The configuration relationship table is mainly used for mass production.

In some embodiments of the present disclosure, by reading the configuration relationship table, all sub-virtual objects to be spliced can be determined, the translation position of the corresponding target area on the sub-virtual object and other sub-virtual objects corresponding to the target area can be read, and the sub-virtual objects can be spliced based on the Transform of each sub-virtual object in its own world space. A splicing algorithm is further introduced below with sub-virtual objects as island components.

In this embodiment, assuming that the main island component is A, the secondary island component is B, and the connector is X, the Transforms of these three components in the world space may be T_{A}, T_{B}, and T_{X} respectively. Moreover, the Transform of the slot of the main island component relative to the main island component itself is T_{JA}, the Transform of the slot of the secondary island component relative to the secondary island component itself is T_{JB}, and the Transforms of the two slots of the connector corresponding to the slot of the main island component and the slot of the secondary island component relative to the connector itself are T_{JX1} and T_{JX2} respectively.

This embodiment can determine the Transform of the spliced connector in the world space according to the Transform of the slot of the main island component. Since

$${T}_{JX 1} \cdot {T}_{X} = {T}_{JA} , {T}_{X} = {T}_{JX 1}^{- 1} \cdot {T}_{JA}$$

can be obtained. According to the relative position relationship, it can be determined that the world Transform of the slot on the other side of the connector is T_{JX2}·T_{X}. This embodiment can determine the world Transform of the spliced secondary island component according to the world Transform of the slot on the other side of the connector. According to

$${T}_{JB} \cdot {T}_{B} = {T}_{JX 2} \cdot {T}_{X} , {T}_{B} = {T}_{JB}^{- 1} \cdot {T}_{JX 2} \cdot {T}_{JX 1}^{1} \cdot {T}_{JA}$$

can be obtained, thereby achieving the purpose that all connectors and secondary island components are spliced to the main island.

In this embodiment, considering the translation and rotation of the main island component itself, the spliced island can be translated and rotated as a whole according to the relative position relationship, and all T_{JA} items in the formula are replaced with T_{JA}·T_{A} to obtain final results: the world Transform of the connector:

$${T}_{X} = {T}_{JX 1}^{- 1} \cdot {T}_{JA} \cdot {T}_{A} ,$$

and the world Transform of the secondary island component:

$${T}_{B} = {T}_{JB}^{- 1} \cdot {T}_{JX 2} \cdot {T}_{JX 1}^{- 1} \cdot {T}_{JA} \cdot {T}_{A} ,$$

thereby achieving the purpose of obtaining a final island.

In some embodiments of the present disclosure, at step S202, the process of respectively acquiring path finding maps of multiple sub-virtual objects includes: path finding resources of each sub-virtual object are generated based on the terrain resources of each sub-virtual object; and the path finding map of each sub-virtual object is generated based on the path finding resources of each sub-virtual object, where the path finding map is composed of polygonal patches of each sub-virtual object.

In this embodiment, each sub-virtual object may include terrain resources and path finding resources. The path finding resources are generated by the editor according to the terrain resources of each sub-virtual object. The path finding resources of each sub-virtual object are divided according to polygonal meshes to generate the path finding map of each sub-virtual object, where the path finding map may be composed of polygonal patches of each sub-virtual object, such as a NavMesh composed of polygons.

In some embodiments of the present disclosure, the terrain resources of the sub-virtual objects can be spliced arbitrarily, and the only difference is whether the splicing effect is beautiful. However, in actual applications, when sub-virtual objects are spliced, the splicing of terrain resources also needs to meet design requirements. The target area can be required to cover a relatively complete area as much as possible. This is only an example and is not specifically limited.

It should be noted that since the path finding resources of this embodiment are generated by terrain resources, the target areas in the polygonal meshes on every two adjacent sub-virtual objects can be overlapped in a priority manner according to the splicing order, so that the sub-virtual objects where the terrain resources corresponding to the path finding resources are located are naturally spliced together.

The above technical solution of the embodiment of the present disclosure is further illustrated below by combining preferred implementations, specifically taking the game scene being an island community scene as an example.

Game scenes are an important part of games, and the number and quality of game scenes will directly affect the game experience of players. With the development of three-dimensional open world games and the increasing requirements of players for game content, the size of existing game scenes is becoming increasingly large, and the level of sophistication is becoming increasingly higher. As a result, the amount of data in game installation packages is also increasing. How to find an efficient method to generate large-scale game scenes with less art workload is a problem that the game industry is concerned about.

For naval warfare games, there are a large number of art resources for island communities that need to be produced, including both terrain resources and path finding resources. Moreover, in order to improve the diversity of the experience, the generation of islands follows certain random rules. However, the difficulty of scene generation lies in what kind of workflow to adopt to simultaneously meet the requirements of low art workload, scene randomness, and controllable data volume of the game installation package.

In related technologies, there is already an idea of procedurally generating art resources. Procedural content generation (PCG) is an algorithm in computer science that allows a procedure to automatically generate a type of data. An ideal PCG solution is to generate a complete game scene that meets certain constraint conditions with one click. In related technologies, a method for achieving an island community scene may be as follows: the island community scene is built in advance by an art scene editor in an offline state; the island community scene is completed by PCG software in an offline state, and then imported into a game engine; or, during operation, simple polygons are implemented through algorithms to build areas to generate the island community scene.

When terrain resources are processed, the corresponding path finding resources also need to be processed. There are many ways to represent the scene map of the path finding resources, such as a two-dimensional mesh method, a waypoint method, and a navigation mesh method. The two-dimensional mesh method divides a scene into two-dimensional meshes with the same size, each two-dimensional mesh can be marked as an obstacle or not, and the path finding way is based on meshes as units and bypasses the meshes marked as obstacles. The waypoint method abstracts a scene into a series of waypoints, the positions and communication relationships of these waypoints can be designed artificially, and a character can move according to the idea of a designer when finding a path. The navigation mesh method (NavMesh) uses a set of convex polygons with different shapes and sizes to represent the entire scene, and uses polygons to cover walkable areas in the scene. Compared with the previous two methods, the navigation mesh method is more flexible. For finding a path in complex scenes, the navigation mesh method is often the preferred method.

In this embodiment, the game scene may be a vast sea with multiple islands, which is random, and the positions, distributions and shapes of the islands may be different every time a player enters the game. Therefore, there are still some problems with the game scene generation methods and path finding methods in related technologies. For example, if editors build all scenes in advance to create a pseudo-random effect, the workload of artists and the volume of art resources will increase exponentially. If the PCG software is used for creating game scenes, the terrain details of the game scenes are less controllable and cannot effectively reflect the aesthetic styles of the artists. A method for randomly generating game scenes through algorithms during operation is more suitable for some game scenes with low accuracy and fewer terrain details. For game scenes with higher accuracy requirements, it is impossible to use a method of random calculation during operation.

The game scene generation methods in related technologies cannot achieve a balance in the randomness of the game scene. Therefore, it is impossible to both reflect the aesthetic styles of the artists and improve the randomness and the degree of scene reuse. As for a method for representing path finding resources, the two-dimensional mesh method and the waypoint method are more suitable for some simple game scenes. Although the navigation mesh method is suitable for finding a path in complex scenes, it does not consider the randomness of scenes.

In order to achieve the purpose of randomly generating irregular island community scenes, this embodiment can design an art workflow so that the volume of art resources can be controlled, the workload of artists can be controlled, the appearance modeling can be enriched, and more random combination modes can be supported. In this way, relatively rich and different terrain resources can be achieved with less art engineering and resource volume, thereby ensuring the normal operation of the terrain path finding system.

In order to solve the above problems, this embodiment provides a game scene generation method which can generate a random irregular island community scene based on modularization. FIG. 4 is a schematic diagram of a game scene formed by splicing island components according to an embodiment of the present disclosure. As shown in FIG. 4, the island community scene to be outputted may be abstractly disassembled and classified and ultimately divided into multiple island components, such as a main island component 401, a secondary island component 402, a secondary island component 403, and a connector 404. Multiple slots can be defined on island components to achieve splicing between the island components. When an island community scene is produced, these island components can be reused for splicing. The main island component 401 and the secondary island component 402 can be spliced through the connector 404 or can be spliced directly without the connector 404, or the end of the connector 404 may not be connected to any secondary island component, for example, a broken bridge on the island needs to be made. Thus, the purpose of reducing the amount of resources and workload is achieved.

FIG. 5 is a schematic diagram of an island tree according to an embodiment of the present disclosure. As shown in FIG. 5, a splicing process of a complete island can be abstracted into a construction process of an island tree. A root node of the island tree is a main island component 501, the root node may have many child nodes or no child nodes, and the child nodes of the root node may represent a connector 502, a connector 503, and a connector 504. The nodes corresponding to the connectors may have child nodes, and the child nodes may be used for representing a secondary island component 505, a secondary island component 506, and a secondary island component 507.

In this embodiment, during the splicing process of island components, in addition to considering the splicing of island components corresponding to terrain resources, the splicing of island components corresponding to path finding resources also needs to be considered. The path finding splicing solution that can be used in this embodiment is Tile-based navigation mesh splicing. The scene path finding can be divided into square areas with a fixed length. Therefore, when island components are spliced, the island components also need to comply with the splicing scale of navigation meshes, and the island components can only be translated according to an integer multiple of square meshes and can only be rotated by 90°.

The purpose of this embodiment is to reduce the art workload and the amount of resources while outputting island communities with rich shapes. Since this embodiment adopts the idea of splicing island components, a scene designer can analyze a game scene from the whole to the part or from the part to the whole.

In the analysis from the whole to the part, the scene designer needs to analyze each island in the final island community scene. Each island can be logically split into a main island component, multiple connectors, and multiple secondary island components, and whether there are reusable island components can be analyzed. Each island component is made according to the analysis results of each island component.

In the analysis from the part to the whole, the scene designer needs to predetermine the type, number and pattern of each island component according to the design style to make various types of island components. Then, according to the size and style of the overall island community, various island components can be spliced to finally obtain an island community scene. However, no matter which idea the scene designer adopts, the island components need to be outputted according to certain specifications, and then, the slots of each island component are defined.

The game scene generation method of this embodiment may include the following steps.

Step 1: Scene terrain patterns of island components are designed.

Scene designers can produce terrain resources of each island component according to design requirements.

Step 2: The terrain origins of the island components are determined.

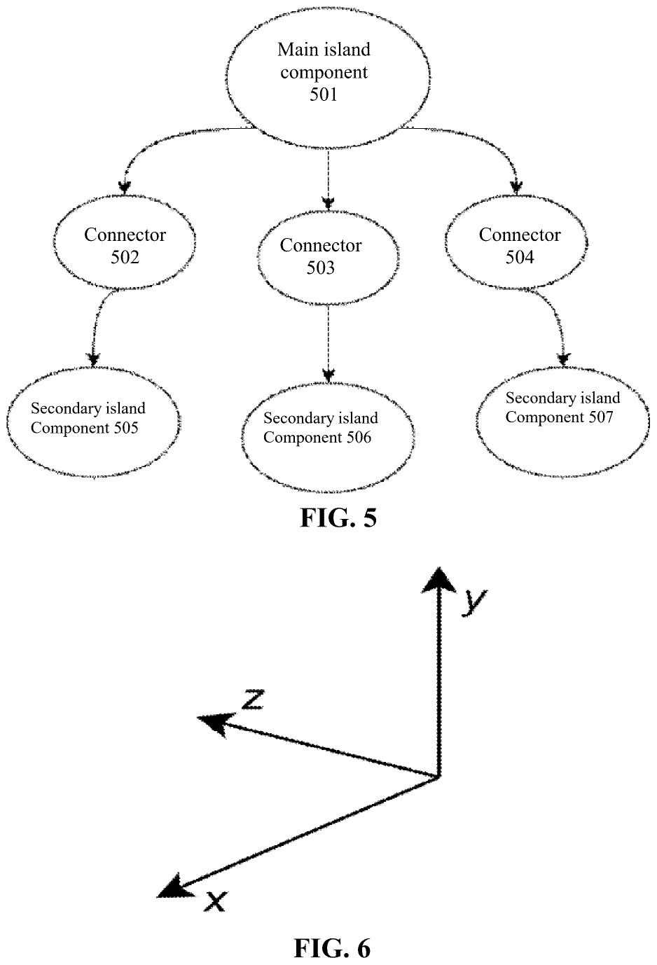

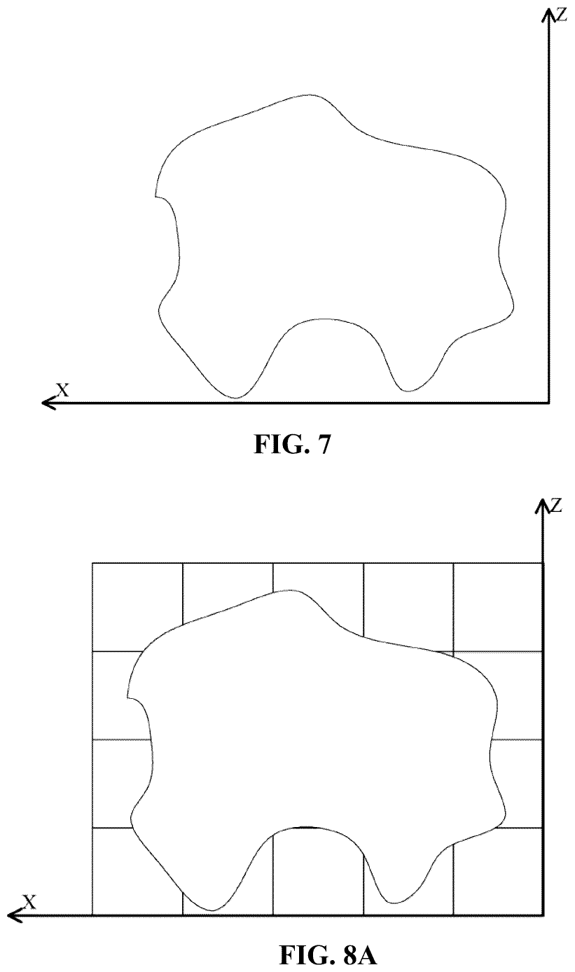

FIG. 6 is a schematic diagram of a coordinate system of a three-dimensional scene according to an embodiment of the present disclosure. As shown in FIG. 6, the game scene is a three-dimensional scene, and the terrain origin in the game scene, the coordinate point (0, 0, 0), can determine the position of the point (0, 0, 0) of the local coordinate system of an island component. FIG. 7 is a schematic diagram of an island component within an area expanded in positive directions of an x axis and a z axis according to an embodiment of the present disclosure. As shown in FIG. 7, the position will be at a corner of a circumscribed rectangle of an island component, and the island component is within an area expanded in positive directions of an x axis and a z axis.

In this embodiment, a complete island component may include two types of resources: scene terrain resources and path finding resources.

In this embodiment, the splicing of the island components corresponding to the terrain resources and the splicing of the island components corresponding to the path finding resources are performed simultaneously. Generally speaking, there are terrain resources first, and then, an editor is used for generating path finding resources one by one according to the terrain resources. From the perspective of splicing, terrain resources can be spliced arbitrarily (the only question is whether it looks good), while path finding resources are polygonal meshes and cannot be spliced arbitrarily. Therefore, when the island components corresponding to the path finding resources are spliced actually, since there are more restrictions on the splicing of the island components corresponding to the path finding resources, it is necessary to determine the splicing solution of all resources by splicing the island components corresponding to the path finding resources.

In this embodiment, a specific method for splicing the island components corresponding to the path finding resources may be the following Tile splicing method for cutting the path finding resources into squares and splicing based on the squares.

In this embodiment, the path finding resources may be generated according to the terrain resources. The island components need to be spliced in subsequent steps, and the splicing rules of the island components corresponding to the path finding resources are different from the splicing rules of the island components corresponding to the terrain resources, where the island components corresponding to the terrain resources can be spliced arbitrarily, but the island components corresponding to the path finding resources are spliced based on the Tile area. Therefore, it is necessary to standardize the terrain resources produced in step 1. For example, looking in the negative direction of the y axis, the main body of the terrain is within an area expanded in the positive direction of the x axis and the positive direction of the z axis in the terrain space, as shown in FIG. 7.

Step 3: The Tile mesh size lₜᵢₗₑ is determined, and slots are defined according to Tile meshes.

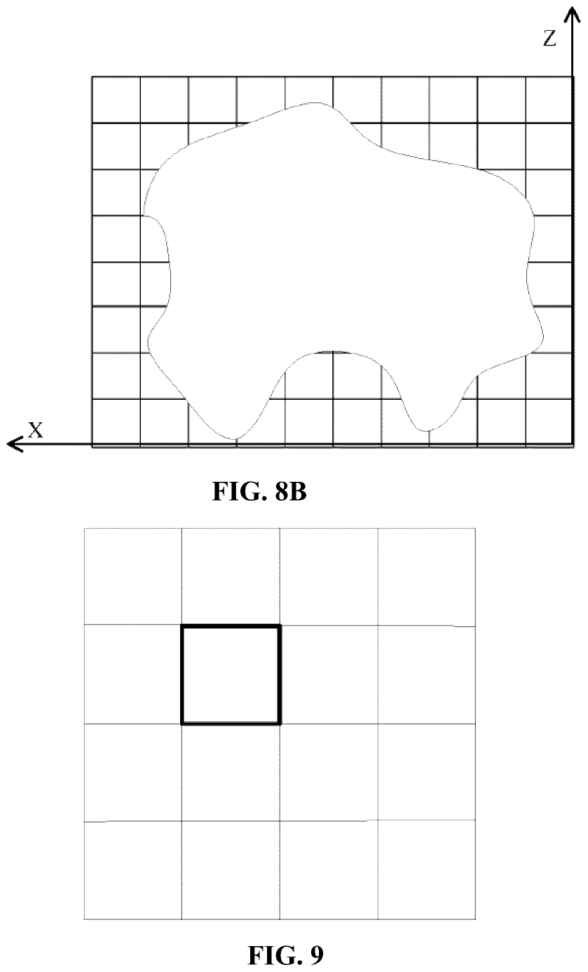

In this embodiment, the path finding resource is based on the Tile area, which is logically equivalent to meshing the top view of the scene, and finally outputting the scene path finding NavMesh corresponding to each mesh. Considering the splicing between multiple island components, an appropriate Tile mesh size lₜᵢₗₑ needs to be selected. FIG. 8(a) is a schematic diagram of the number of path finding map segments corresponding to a larger size lₜᵢₗₑ according to an embodiment of the present disclosure. FIG. 8(b) is a schematic diagram of the number of path finding map segments corresponding to a smaller size lₜᵢₗₑ according to an embodiment of the present disclosure. As shown in FIG. 8(a) and FIG. 8(b), the larger the lₜᵢₗₑ, the more path finding resources can be saved, but the splicing accuracy is lower; and the larger the lₜᵢₗₑ, the more path finding resources are consumed, but the splicing accuracy is higher.

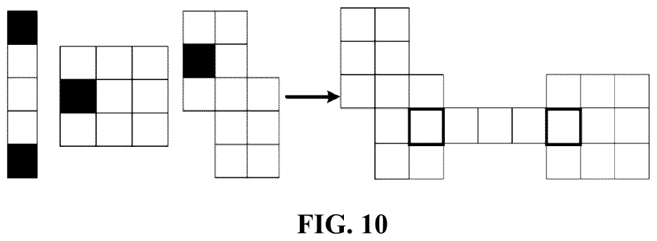

In this embodiment, slots are some designated Tile areas on island components. FIG. 9 is a schematic diagram of Tile areas in a path finding resource according to an embodiment of the present disclosure. As shown in FIG. 9, a square block surrounded by thick lines can be a Tile area, where the Tile areas refer to adjacent square blocks in a path finding mesh, and the square block here only represents the area but does not represent the position. In this embodiment, the Tile area is a designated square area of the path finding resource on the island component. During splicing, this area is overlapped and aligned with the Tile areas of other island components, which represents logical splicing. It should be noted that the Tile area here refers to a slot, as shown in FIG. 10. FIG. 10 is a schematic diagram of slots according to an embodiment of the present disclosure. Black solid square blocks are slots for splicing on island components. Black hollow square blocks are slots overlapped when island components are spliced. When two island components are spliced, one slot on each island component needs to be overlapped completely.

In this embodiment, since the Tile area is a square area, it theoretically supports splicing in four directions. When island components are spliced according to Tile rules, the splicing of island components corresponding to terrain resources also needs to meet design requirements, which requires that the slots cover a relatively complete island area as much as possible. Moreover, as shown in FIG. 8(a), since the side length of the slot is also lₜᵢₗₑ, the larger the lₜᵢₗₑ is, the lower the splicing accuracy is. The final determination of lₜᵢₗₑ requires scene designers to make certain trade-offs.

In this embodiment, the side length of the above slot may be the side length of a square mesh. When the side length is smaller, the file volume of the path finding resources is larger, and the path finding accuracy can be improved. When the side length is larger, the file volume of the path finding resources is smaller, and the path finding accuracy can be reduced. Furthermore, the side length of the slot may be the same as the side length of the square mesh. The actual value may be an empirical value according to the situation of a project.

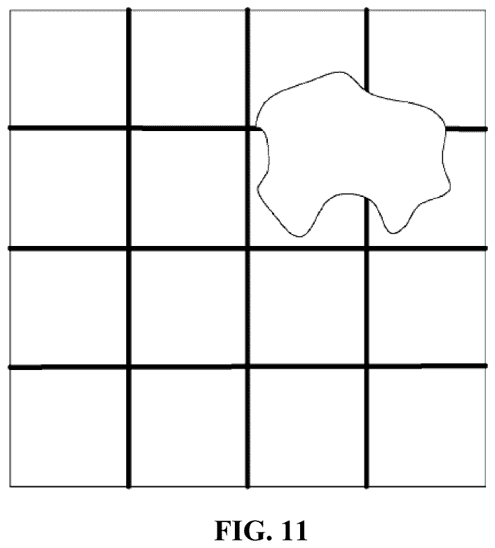

In this embodiment, the path finding can be represented as a square mesh, as shown in FIG. 11. FIG. 11 is a schematic diagram of a square mesh according to an embodiment of the present disclosure. The scene path finding is divided into a square mesh by thick lines. Actual path finding resources are fit to a terrain, but are cut into squares.

Step 4: Path finding resources are outputted according to Tile meshes.

In this embodiment, the terrain resources and path finding resources of each island component have been determined, and the path finding NavMesh of each island component can be generated according to Tile division. The path finding map produced by each island component may include multiple path finding files, the number of path finding files may be the same as the number of Tile areas divided in the island component, and both have a one-to-one correspondence relationship.

Step 5: Island components are spliced.

In this embodiment, after the island components corresponding to the terrain resources and path finding resources are produced, a certain mechanism is required to allow the island components to be spliced together as needed. Island components are divided into main island components, secondary island components, and connectors. In this embodiment, multiple slots can be defined on the main island component, one slot can be defined on the secondary island component, and one slot can be defined at the head and tail of the connector respectively. The splicing result may be main island component+connector+secondary island component, where the main island may define its own translation and rotation. Since the meshes of path finding Tiles need to be aligned, the values in x and z directions of translation may be an integer multiple of lₜᵢₗₑ, and the rotation angle may be an integer multiple of 90°.

In some embodiments, the translation and rotation of the main island component can be ignored, and the connectors and the secondary island components can be spliced first. As shown in FIG. 10, solid black square blocks represent the slots of the island components. The first island component may represent the connector, which has two slots. The last two island components may be a main island component and a secondary island component respectively, each with one slot. When each island component is loaded into the scene, the connectors and the secondary island components can be spliced to the main island component based on the position of the main island component. Hollow square blocks with bold black lines in the figure represent the overlapped slots between the main island component and secondary island component and the connector. During splicing, the connectors and the secondary island components need to be rotated and translated to appropriate positions to complete the splicing. For rotation, since it is based on square splicing, the rotation angle is an integer multiple of 90; and for translation, the translation amount is an integer multiple of the side length of the square. After the connectors and the secondary island components are spliced to the main island component, the translation and rotation of the main island component are considered, and the entire spliced island is rotated and translated. The corresponding relationship among the slots of each connector, each secondary island component and the main island component can be defined through a configuration table.

It should be noted that the island component may include square areas (Tile areas), but the island component may not be equivalent to the square area. The connector, main island component and secondary island component shown in FIG. 10 may all include multiple square areas. However, FIG. 10 is only schematic. The island component just may be divided into multiple square areas while the actual island component is irregular.

An island splicing algorithm of this embodiment is further introduced below.

Step 1: A configuration table is read to obtain all island components to be spliced.

In this embodiment, the configuration table is customized by a project, and the main function is to provide island splicing information. For example, the island splicing information may be the position of the main island. If there are multiple slots on the main island, the splicing information can also provide which secondary island component each slot corresponds to and which connector to use. The configuration table can be mainly used for mass production.

This embodiment can read the translation position of the corresponding slot on the main island component, the corresponding connector on the slot, and the secondary island component corresponding to the connector.

In this embodiment, assuming that the main island component is A, the secondary island component is B, and the connector is X, the Transforms of these three components in the world space may be T_{A}, T_{B}, and T_{X} respectively. Moreover, the Transform of the slot of the main island component relative to the main island component itself is T_{JA}, the Transform of the slot of the secondary island component relative to the secondary island component itself may be T_{JB}, and the Transforms of the two slots of the connector corresponding to the slot of the main island component and the slot of the secondary island component relative to the connector itself may be T_{JX1} and T_{JX2} respectively.

In some embodiments, an editor can make a selection in an island component library to procedurally generate a required island by means of the above configuration table.

Step 2: The Transform of the spliced connector in the world space is determined according to the Transform of the slot of the main island component. Since

$${T}_{JX 1} \cdot {T}_{X} = {T}_{JA} , {T}_{X} = {T}_{JX 1}^{- 1} \cdot {T}_{JA}$$

can be obtained. This embodiment can determine the world Transform of the slot on the other side of the connector as T_{JX2}·T_{X} according to the relative position relationship.

Step 3: The world Transform of the spliced secondary island component can be determined according to the world Transform of the slot on the other side of the connector. Since

$${T}_{JB} \cdot {T}_{B} = {T}_{JX 2} \cdot {T}_{X} , {T}_{B} = {T}_{JB}^{- 1} \cdot {T}_{JX 2} \cdot {T}_{JX 1}^{- 1} \cdot {T}_{JA}$$

can be obtained.

Thus, all connectors and secondary island components are spliced to the main island component.

Step 4: Considering the translation and rotation of the main island component itself, the entire spliced island can be translated and rotated according to the relative position relationship to finally obtain the required island. All T_{JA} items in the above formula can be replaced with T_{JA}·T_{A} to obtain the following final results:

The world Transform of the connector:

$${T}_{X} = {T}_{JX 1}^{- 1} \cdot {T}_{JA} \cdot {T}_{A} .$$

The world Transform of the secondary island component:

$${T}_{B} = {T}_{JB}^{- 1} \cdot {T}_{JX 2} \cdot {T}_{JX 1}^{- 1} \cdot {T}_{JA} \cdot {T}_{A} .$$

Step 6: A required scene is constructed by the spliced island.

Thus, the splicing process for an island is completed.

It should be noted that this embodiment can generate a random terrain based on modular irregular plots, which is not only applicable to island splicing, but can also be expanded to the splicing of dungeon and maze scenes. The details are not illustrated one by one here.

This embodiment proposes a method for producing a random and irregular island community. A scene designer can make a selection in an island component library to procedurally generate a required island by means of a configuration table. In the entire process, the reusability of island components is greatly improved, the workload of artists can be fully reduced, and the total amount of art resources can be reduced. In this embodiment, large scenes and randomly generated levels are main features, and are also important guarantees for enriching the gameplay. The method of this embodiment can ensure a certain degree of scene diversity, so that every time a player enters the game, the positions and types of islands are different, which can improve the richness of game scenes.

Through the description of the above implementations, those skilled in the art can clearly understand that the method according to the above embodiment can be implemented by means of software and a necessary general hardware platform, and/or by hardware, but the former is a better implementation in some embodiments. Based on this understanding, the technical solution of the present disclosure, or the part that contributes to the prior art can be embodied in the form of a software product. The computer software product is stored in a storage medium (e.g., an ROM/RAM, a magnetic disk, or an optical disk), including multiple instructions for instructing a terminal device (which may be a mobile phone, a computer, a server, a network device, etc.) to execute the method of each embodiment of the present disclosure.

In this embodiment, a game scene generation apparatus is also provided. The apparatus is used for implementing the above embodiments and preferred implementations, and those that have been explained will not be repeated here. As used below, the term “unit” may be a combination of software and/or hardware that implements a predetermined function. Although the apparatuses described in the following embodiments are preferably implemented in software, implementation in hardware or a combination of software and hardware is also possible and conceivable.

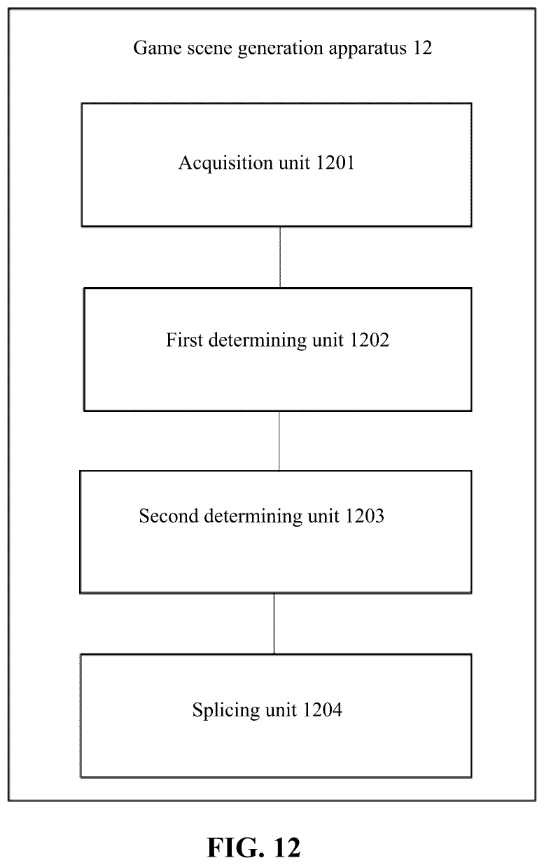

FIG. 12 is a schematic diagram of a game scene generation apparatus according to an embodiment of the present disclosure. As shown in FIG. 12, a game scene generation apparatus 12 includes: an acquisition unit 1201, a first determining unit 1202, a second determining unit 1203, and a splicing unit 1204.

The acquisition unit 1201 is configured to respectively acquire path finding maps of multiple sub-virtual objects, where the path finding map is used for guiding a virtual game character to find a path on the terrain of the corresponding sub-virtual object.

The first determining unit 1202 is configured to determine multiple reference lines of the path finding map of each sub-virtual object, where the reference lines are used for enabling the virtual game character to find a path from the terrain of each sub-virtual object to the terrain of a sub-virtual object other than the each sub-virtual object in the multiple sub-virtual objects.

The second determining unit 1203 is configured to determine at least one target geometric area in the path finding map based on the multiple reference lines.

The splicing unit 1204 is configured to splice the multiple sub-virtual objects according to the at least one target geometric area corresponding to each sub-virtual object to obtain a game scene, where the virtual game character finds a path on the terrain of the game scene.

In some embodiments, the first determining unit may include: a first determining module, configured to determine the multiple reference lines based on a local coordinate system where the path finding map is located.

In some embodiments, the first determining module may include: a first determining sub-module, configured to take the origin of the coordinate system as a reference, determine a reference line perpendicular to a first coordinate axis at intervals of a target size along the first coordinate axis of the coordinate system, and determine a reference line perpendicular to a second coordinate axis at intervals of the target size along the second coordinate axis of the coordinate system, so as to obtain the multiple reference lines, where the first coordinate axis and the second coordinate axis are perpendicular to each other.

In some embodiments, the target size is negatively correlated with the accuracy of splicing the multiple sub-virtual objects.

In some embodiments, the first determining unit may include: a second determining module, configured to determine the origin of the local coordinate system where the terrain of each sub-virtual object is located as the origin of the coordinate system where the path finding map is located.

In some embodiments, the second determining unit may include: a dividing module, configured to divide the path finding map into multiple square areas based on the multiple reference lines; and a third determining module, configured to determine at least one target square area in the multiple square areas, where the at least one target geometric area includes the at least one target square area.

In some embodiments, the third determining module may include: a second determining sub-module, configured to determine at least one square area located at an edge position of each corresponding sub-virtual object in the multiple square areas as the at least one target square area.

In some embodiments, the splicing unit may include: an overlapping module, configured to overlap the corresponding at least one target geometric area in the path finding map of a first sub-virtual object with the corresponding at least one target geometric area in the path finding map of a second sub-virtual object based on the association relationship between the first sub-virtual object and the second sub-virtual object to obtain the game scene, where the first sub-virtual object and the second sub-virtual object are any two sub-virtual objects in the multiple sub-virtual objects, and the association relationship is used for indicating that the virtual game character is allowed to find a path between the terrain of the first sub-virtual object and the terrain of the second sub-virtual object.

In some embodiments, the overlapping module may include: a third determining sub-module, configured to determine at least one first sub-path finding map on the corresponding at least one target geometric area in the path finding map of the first sub-virtual object; a fourth determining sub-module, configured to determine at least one second sub-path finding map on the corresponding at least one target geometric area in the path finding map of the second sub-virtual object; and an overlapping sub-module, configured to overlap the at least one first sub-path finding map and the at least one second sub-path finding map to obtain a target path finding map, where the path finding map is located within an area defined by the multiple reference lines. The game scene is generated based on the target path finding map.

In some embodiments, the splicing unit may further include: a third determining unit, configured to determine orientation adjustment information of the second sub-virtual object in the world space based on a first current orientation in the world space of the corresponding at least one target geometric area in the path finding map of the first sub-virtual object and a second current orientation in the world space of the corresponding at least one target geometric area in the path finding map of the second sub-virtual object, where the first current orientation and the second current orientation are randomly determined orientations, and the orientation adjustment information is used for representing information for adjusting the position of the second sub-virtual object in the world space and/or information for adjusting the direction of the second sub-virtual object in the world space; and an adjusting unit, configured to adjust the current orientation of the second sub-virtual object in the world space based on the orientation adjustment information so that the corresponding at least one target geometric area in the path finding map of the first sub-virtual object is overlapped with the corresponding at least one target geometric area in the path finding map of the adjusted second sub-virtual object.

In some embodiments, the apparatus may further include: a reading unit, configured to read the first sub-virtual object and the second sub-virtual object and the association relationship in a configuration relationship table, where the configuration relationship table includes identifiers of the multiple sub-virtual objects, and includes an association relationship between every two sub-virtual objects in the multiple sub-virtual objects, and the association relationship between every two sub-virtual objects is used for indicating that the virtual game character is allowed to find a path between the terrains of the every two sub-virtual objects.

In some embodiments, the acquisition unit may include: a first generation module, configured to generate path finding resources of each sub-virtual object based on the terrain resources of each sub-virtual object; and a second generation module, configured to generate the path finding map of each sub-virtual object based on the path finding resources of each sub-virtual object, where the path finding map is composed of polygonal patches of each sub-virtual object.

It should be noted that the above units may be implemented by software or hardware. For the latter, it may be implemented in the following ways, but not limited to: the above units are all located in the same processor, or the above units are respectively located in different processors in any combination form.

In the game scene generation apparatus according to this embodiment, the acquisition unit is configured to respectively acquire path finding maps of multiple sub-virtual objects; the first determining unit is configured to determine multiple reference lines of the path finding map of each sub-virtual object; the second determining unit is configured to determine at least one target geometric area in the path finding map based on the multiple reference lines; and the splicing unit is configured to splice the multiple sub-virtual objects according to the at least one target geometric area corresponding to each sub-virtual object to obtain a game scene, thereby achieving the purpose of ensuring the normal operation of a terrain path finding system, and solving the technical problem that effective path finding cannot be ensured during generation of a game scene.

An embodiment of the present disclosure further provides a non-volatile storage medium. The non-volatile storage medium stores a computer program, where the computer program is configured to implement the steps of any one of the above method embodiments when the computer program is executed.

In some embodiments, the above non-volatile storage medium may include but is not limited to: a USB flash drive, a read-only memory (ROM), a random access memory (RAM), a mobile hard disk, a magnetic disk, an optical disk, or other media that can store computer programs.

In some embodiments, the above non-volatile storage medium may be located in any computer terminal in a computer terminal group in a computer network, or in any mobile terminal in a mobile terminal group.

In some embodiments, the above non-volatile storage medium may be configured to store a computer program for executing the following steps: respectively acquiring path finding maps of multiple sub-virtual objects, where the path finding map is used for guiding a virtual game character to find a path on the terrain of the corresponding sub-virtual object; determining multiple reference lines of the path finding map of each sub-virtual object, where the reference lines are used for enabling the virtual game character to find a path from the terrain of each sub-virtual object to the terrain of a sub-virtual object other than the each sub-virtual object in the multiple sub-virtual objects; determining at least one target geometric area in the path finding map based on the multiple reference lines; and splicing the multiple sub-virtual objects according to the at least one target geometric area corresponding to each sub-virtual object to obtain a game scene, where the virtual game character finds a path on the terrain of the game scene.

In some embodiments, the above processor may also be configured to perform the following step through a computer program: determining the multiple reference lines based on a local coordinate system where the path finding map is located.

In some embodiments, the above processor may also be configured to perform the following step through a computer program: taking the origin of the coordinate system as a reference, determining a reference line perpendicular to a first coordinate axis at intervals of a target size along the first coordinate axis of the coordinate system, and determining a reference line perpendicular to a second coordinate axis at intervals of the target size along the second coordinate axis of the coordinate system, so as to obtain the multiple reference lines, where the first coordinate axis and the second coordinate axis are perpendicular to each other.

In some embodiments, the target size is negatively correlated with the accuracy of splicing the multiple sub-virtual objects.

In some embodiments, the above processor may also be configured to perform the following step through a computer program: determining the origin of the local coordinate system where the terrain of each sub-virtual object is located as the origin of the coordinate system where the path finding map is located.

In some embodiments, the above processor may also be configured to perform the following steps through a computer program: dividing the path finding map into multiple square areas based on the multiple reference lines; and determining at least one target square area in the multiple square areas, where the at least one target geometric area includes the at least one target square area.

In some embodiments, the above processor may also be configured to perform the following step through a computer program: determining at least one square area located at an edge position of each corresponding sub-virtual object in the multiple square areas as the at least one target square area.

In some embodiments, the above processor may also be configured to perform the following step through a computer program: overlapping the corresponding at least one target geometric area in the path finding map of a first sub-virtual object with the corresponding at least one target geometric area in the path finding map of a second sub-virtual object based on the association relationship between the first sub-virtual object and the second sub-virtual object to obtain the game scene, where the first sub-virtual object and the second sub-virtual object are any two sub-virtual objects in the multiple sub-virtual objects, and the association relationship is used for indicating that the virtual game character is allowed to find a path between the terrain of the first sub-virtual object and the terrain of the second sub-virtual object.

In some embodiments, the above processor may also be configured to perform the following steps through a computer program: determining at least one first sub-path finding map on the corresponding at least one target geometric area in the path finding map of the first sub-virtual object; determining at least one second sub-path finding map on the corresponding at least one target geometric area in the path finding map of the second sub-virtual object; overlapping the at least one first sub-path finding map and the at least one second sub-path finding map to obtain a target path finding map, where the path finding map is located within an area defined by the multiple reference lines; and generating the game scene based on the target path finding map.

In some embodiments, the above processor may also be configured to perform the following steps through a computer program: determining orientation adjustment information of the second sub-virtual object in the world space based on a first current orientation in the world space of the corresponding at least one target geometric area in the path finding map of the first sub-virtual object and a second current orientation in the world space of the corresponding at least one target geometric area in the path finding map of the second sub-virtual object, where the first current orientation and the second current orientation are randomly determined orientations, and the orientation adjustment information is used for representing information for adjusting the position of the second sub-virtual object in the world space and/or information for adjusting the direction of the second sub-virtual object in the world space; and adjusting the current orientation of the second sub-virtual object in the world space based on the orientation adjustment information so that the corresponding at least one target geometric area in the path finding map of the first sub-virtual object is overlapped with the corresponding at least one target geometric area in the path finding map of the adjusted second sub-virtual object.

In some embodiments, the above processor may also be configured to perform the following step through a computer program: reading the first sub-virtual object and the second sub-virtual object and the association relationship in a configuration relationship table, where the configuration relationship table includes identifiers of the multiple sub-virtual objects, and includes an association relationship between every two sub-virtual objects in the multiple sub-virtual objects, and the association relationship between every two sub-virtual objects is used for indicating that the virtual game character is allowed to find a path between the terrains of the every two sub-virtual objects.

In some embodiments, the above processor may also be configured to perform the following steps through a computer program: generating path finding resources of each sub-virtual object based on the terrain resources of each sub-virtual object; and generating the path finding map of each sub-virtual object based on the path finding resources of each sub-virtual object, where the path finding map is composed of polygonal patches of each sub-virtual object.

In the non-volatile storage medium of this embodiment, a technical solution for generating a game scene is provided. In this solution, the target geometric area corresponding to each sub-virtual object is determined in the path finding map based on multiple reference lines of the path finding map of each sub-virtual object, and then, multiple sub-virtual objects are spliced according to the target geometric area to obtain a game scene. Moreover, the spliced path finding map is still effective in the game scene to achieve the purpose of ensuring the normal operation of a terrain path finding system, thereby achieving the technical effect of ensuring effective path finding during generation of a game scene, and further solving the technical problem that effective path finding cannot be ensured during generation of a game scene.

Through the description of the above implementations, those skilled in the art can easily understand that the example implementations described here may be implemented by software, or by combining software with necessary hardware. Therefore, the technical solution according to the implementations of the present disclosure may be embodied in the form of a software product. The software product may be stored in a computer-readable storage medium (which may be a CD-ROM, a USB flash drive, a mobile hard disk, etc.) or on a network, and includes a number of instructions to enable a computing device (which may be a personal computer, a server, a terminal device, a network device, etc.) to execute the method according to the implementations of the present disclosure.

In an embodiment of this application, a computer-readable storage medium stores a program product capable of implementing the above method in this embodiment. In some possible implementations, various aspects of the embodiments of the present disclosure may also be implemented in the form of a program product, which includes a program code. When the program product runs on a terminal device, the program code is used for enabling the terminal device to execute the steps described in the above “exemplary method” section in this embodiment according to various exemplary implementations of the present disclosure.

The program product for implementing the above method according to the implementations of the present disclosure may adopt a portable compact disk read-only memory (CD-ROM) and include a program code, and may run on a terminal device, such as a personal computer. However, the program product in the embodiments of the present disclosure is not limited thereto. In the embodiments of the present disclosure, the computer-readable storage medium may be any tangible medium containing or storing a program, and the program may be used by or in combination with an instruction execution system, apparatus, or device.

The above program product may take the form of any combination of one or more computer-readable media. The computer-readable storage medium may be, for example but not limited to, an electronic, magnetic, optical, electromagnetic, infrared, or semiconductor system, apparatus, or device, or any combination thereof. More specific examples (a non-exhaustive list) of computer-readable storage media include: an electrical connection having one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

It should be noted that the program code contained in the computer-readable storage medium may be transmitted using any appropriate medium, including but not limited to wireless, wired, optical cable, RF, etc., or any suitable combination of the above.

An embodiment of the present disclosure further provides an electronic apparatus, including a memory and a processor. The memory stores a computer program, and the processor is configured to execute the computer program to implement the steps in any one of the above method embodiments.

In some embodiments, the above electronic apparatus may further include a transmission device and an input/output device, where the transmission device is connected to the above processor, and the input/output device is connected to the above processor.

In some embodiments, the above processor may be configured to execute the following steps through a computer program: respectively acquiring path finding maps of multiple sub-virtual objects, where the path finding map is used for guiding a virtual game character to find a path on the terrain of the corresponding sub-virtual object; determining multiple reference lines of the path finding map of each sub-virtual object, where the reference lines are used for enabling the virtual game character to find a path from the terrain of each sub-virtual object to the terrain of a sub-virtual object other than the each sub-virtual object in the multiple sub-virtual objects; determining at least one target geometric area in the path finding map based on the multiple reference lines; and splicing the multiple sub-virtual objects according to the at least one target geometric area corresponding to each sub-virtual object to obtain a game scene, where the virtual game character finds a path on the terrain of the game scene.

In some embodiments, the above processor may also be configured to execute the following step through a computer program: determining the multiple reference lines based on a local coordinate system where the path finding map is located.

In some embodiments, the above processor may also be configured to execute the following step through a computer program: taking the origin of the coordinate system as a reference, determining a reference line perpendicular to a first coordinate axis at intervals of a target size along the first coordinate axis of the coordinate system, and determining a reference line perpendicular to a second coordinate axis at intervals of the target size along the second coordinate axis of the coordinate system, so as to obtain the multiple reference lines, where the first coordinate axis and the second coordinate axis are perpendicular to each other.

In some embodiments, the target size is negatively correlated with the accuracy of splicing the multiple sub-virtual objects.

In some embodiments, the above processor may also be configured to execute the following step through a computer program: determining the origin of the local coordinate system where the terrain of each sub-virtual object is located as the origin of the coordinate system where the path finding map is located.

In some embodiments, the above processor may also be configured to execute the following steps through a computer program: dividing the path finding map into multiple square areas based on the multiple reference lines; and determining at least one target square area in the multiple square areas, where the at least one target geometric area includes the at least one target square area.

In some embodiments, the above processor may also be configured to execute the following step through a computer program: determining at least one square area located at an edge position of each corresponding sub-virtual object in the multiple square areas as the at least one target square area.

In some embodiments, the above processor may also be configured to execute the following step through a computer program: overlapping the corresponding at least one target geometric area in the path finding map of a first sub-virtual object with the corresponding at least one target geometric area in the path finding map of a second sub-virtual object based on the association relationship between the first sub-virtual object and the second sub-virtual object to obtain the game scene, where the first sub-virtual object and the second sub-virtual object are any two sub-virtual objects in the multiple sub-virtual objects, and the association relationship is used for indicating that the virtual game character is allowed to find a path between the terrain of the first sub-virtual object and the terrain of the second sub-virtual object.

In some embodiments, the above processor may also be configured to execute the following steps through a computer program: determining at least one first sub-path finding map on the corresponding at least one target geometric area in the path finding map of the first sub-virtual object; determining at least one second sub-path finding map on the corresponding at least one target geometric area in the path finding map of the second sub-virtual object; overlapping the at least one first sub-path finding map and the at least one second sub-path finding map to obtain a target path finding map, where the path finding map is located within an area defined by the multiple reference lines; and generating the game scene based on the target path finding map.

In some embodiments, the above processor may also be configured to execute the following steps through a computer program: determining orientation adjustment information of the second sub-virtual object in the world space based on a first current orientation in the world space of the corresponding at least one target geometric area in the path finding map of the first sub-virtual object and a second current orientation in the world space of the corresponding at least one target geometric area in the path finding map of the second sub-virtual object, where the first current orientation and the second current orientation are randomly determined orientations, and the orientation adjustment information is used for representing information for adjusting the position of the second sub-virtual object in the world space and/or information for adjusting the direction of the second sub-virtual object in the world space; and adjusting the current orientation of the second sub-virtual object in the world space based on the orientation adjustment information so that the corresponding at least one target geometric area in the path finding map of the first sub-virtual object is overlapped with the corresponding at least one target geometric area in the path finding map of the adjusted second sub-virtual object.

In some embodiments, the above processor may also be configured to execute the following step through a computer program: reading the first sub-virtual object and the second sub-virtual object and the association relationship in a configuration relationship table, where the configuration relationship table includes identifiers of the multiple sub-virtual objects, and includes an association relationship between every two sub-virtual objects in the multiple sub-virtual objects, and the association relationship between every two sub-virtual objects is used for indicating that the virtual game character is allowed to find a path between the terrains of the every two sub-virtual objects.

In some embodiments, the above processor may also be configured to execute the following steps through a computer program: generating path finding resources of each sub-virtual object based on the terrain resources of each sub-virtual object; and generating the path finding map of each sub-virtual object based on the path finding resources of each sub-virtual object, where the path finding map is composed of polygonal patches of each sub-virtual object.

In the electronic apparatus of this embodiment, a technical solution for generating a game scene is provided. In this solution, the target geometric area corresponding to each sub-virtual object is determined in the path finding map based on multiple reference lines of the path finding map of each sub-virtual object, and then, multiple sub-virtual objects are spliced according to the target geometric area to obtain a game scene. Moreover, the spliced path finding map is still effective in the game scene to achieve the purpose of ensuring the normal operation of a terrain path finding system, thereby achieving the technical effect of ensuring effective path finding during generation of a game scene, and further solving the technical problem that effective path finding cannot be ensured during generation of a game scene.

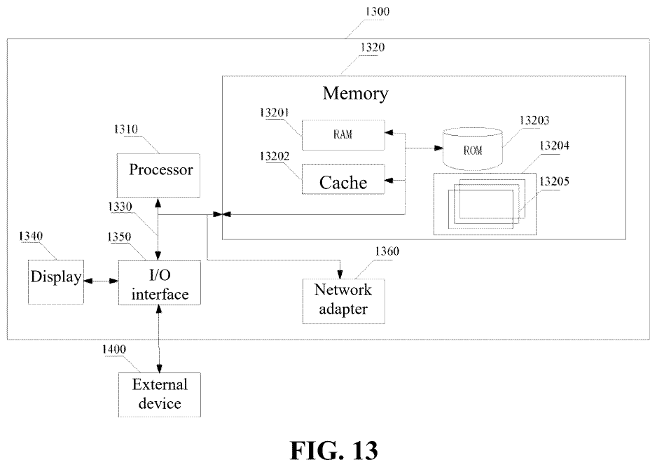

FIG. 13 is a schematic diagram of an electronic apparatus according to an embodiment of the present disclosure. As shown in FIG. 13, an electronic apparatus 1300 is merely an example and should not bring any limitation to the functions and scope of use of the embodiments of the present disclosure.

As shown in FIG. 13, the electronic apparatus 1300 is represented in the form of a general-purpose computing device. The components of the electronic apparatus 1300 may include, but are not limited to: the at least one above processor 1310, the at least one above memory 1320, a bus 1330 connecting different system components (including the memory 1320 and the processor 1310), and a display 1340.

The above memory 1320 stores a program code, and the program code may be executed by the processor 1310, so that the processor 1310 executes the steps described in the above method section in the embodiments of this application according to various exemplary implementations of the present disclosure.

The memory 1320 may include a readable medium in the form of a volatile storage unit, such as a random access memory (RAM) unit 13201 and/or a cache memory unit 13202, may further include a read-only memory (ROM) unit 13203, and may also include a non-volatile memory, such as one or more magnetic storage apparatuses, flash memories, or other non-volatile solid-state memories.

In some embodiments, the memory 1320 may also include a program/utility 13204 having a set of (at least one) program modules 13205, such program modules 13205 including but not limited to: an operating system, one or more application programs, other program modules, and program data. Each of these examples or a certain combination may include an implementation of a network environment. The memory 1320 may further include memories remotely arranged relative to the processor 1310, and these remote memories may be connected to the electronic apparatus 1300 via a network. Examples of the above network include, but are not limited to, the Internet, an intranet, a local area network, a mobile communication network, and combinations thereof.

The bus 1330 may represent one or more of several types of bus structures, including a memory unit bus or memory unit controller, a peripheral bus, an accelerated graphics port, a local bus of the processor 1310, or a local bus using any of various bus structures.

The display 1340 may be, for example, a touch screen type liquid crystal display (LCD), and the LCD may enable a user to interact with a user interface of the electronic apparatus 1300.

In some embodiments, the electronic apparatus 1300 may also communicate with one or more external devices 1400 (e.g., a keyboard, a pointing device, a Bluetooth device, etc.), with one or more devices that enable a user to interact with the electronic apparatus 1300, and/or with any device that enables the electronic apparatus 1300 to communicate with one or more other computing devices (e.g., a router, a modem, etc.). Such communication may be performed through an input/output (I/O) interface 1350. Furthermore, the electronic apparatus 1300 may also communicate with one or more networks (e.g., a local area network (LAN), a wide area network (WAN), and/or a public network, such as the Internet) through a network adapter 1360. As shown in FIG. 13, the network adapter 1360 communicates with other modules of the electronic apparatus 1300 through the bus 1330. It should be understood that although not shown in FIG. 13, other hardware and/or software modules may be used in conjunction with the electronic apparatus 1300, including but not limited to: microcodes, device drivers, redundant processing units, external disk drive arrays, RAID systems, tape drives, data backup storage systems, etc.

The above electronic apparatus 1300 may further include: a keyboard, a cursor control device (e.g., a mouse), an input/output interface (I/O interface), a network interface, a power supply, and/or a camera.

Those of ordinary skill in the art can understand that the structure shown in FIG. 13 is merely illustrative and does not limit the structure of the above electronic apparatus. For example, the electronic apparatus 1300 may also include more or fewer components than those shown in FIG. 13, or have a configuration different from that shown in FIG. 1. The memory 1320 can be used for storing computer programs and corresponding data, such as computer programs and corresponding data corresponding to a cloud desktop login verification method, a cloud desktop control system, and a client method in the embodiments of the present disclosure. The processor 1310 implements various functional applications and data processing by executing the computer program stored in the memory 1320, thereby achieving the above game scene generation method.

The serial numbers of the above embodiments of the present disclosure are only for description, and do not represent the advantages or disadvantages of the embodiments.

In the above embodiments of the present disclosure, the description of each embodiment has its own emphasis. For parts that are not described in detail in a certain embodiment, reference can be made to the relevant descriptions of other embodiments.

In the embodiments provided in the present disclosure, it should be understood that the disclosed technical contents can be implemented in other ways. The apparatus embodiments described above are only schematic. For example, the division of units may be a logical function division. There may be other division methods in actual implementations. For example, multiple units or components may be combined or integrated into another system, or some features may be ignored or not executed. Another point is that the mutual coupling or direct coupling or communication connection shown or discussed may be indirect coupling or communication connection through some interfaces, units or modules, and may be in electrical or other forms.

The units described as separate components may or may not be physically separated, and the components shown as units may or may not be physical units, and may be located in one place or may be distributed to multiple units. Some or all of the units may be selected according to actual needs to achieve the purpose of the solution in this embodiment.

In addition, each functional unit in each embodiment of the present disclosure may be integrated into one processing unit, or each unit may physically exist separately, or two or more units may be integrated into one unit. The above integrated unit may be implemented in the form of hardware, or may be implemented in the form of a software functional unit.

If the integrated unit is implemented in the form of a software functional unit and sold or used as an independent product, the integrated unit may be stored in a computer-readable storage medium. Based on this understanding, the technical solution of the present disclosure, or the part that contributes to the prior art, or all or part of the technical solution can be embodied in the form of a software product. The computer software product is stored in a storage medium, including multiple instructions for instructing a computer device (which may be a personal computer, a server, a network device, etc.) to execute all or some of the steps of the method described in each embodiment of the present disclosure. The above storage media include: USB flash drives, Read-Only Memories (ROM), Random Access Memories (RAM), mobile hard disks, magnetic disks or optical disks, and other media that can store program codes.

The above implementations are only preferred implementations of the present disclosure. It should be noted that those of ordinary skill in the art can make various improvements and modifications without departing from the principles of the present disclosure. These improvements and modifications should also be encompassed within the scope of protection of the present disclosure.

1. A game scene generation method, comprising:
acquiring path finding maps of a plurality of sub-virtual objects, wherein a path finding map is configured for guiding a virtual game character to find a path on a terrain of a corresponding sub-virtual object;
determining a plurality of reference lines of the path finding map of the corresponding sub-virtual object, wherein the plurality of reference lines are configured for enabling the virtual game character to find a path from the terrain of the corresponding sub-virtual object to a terrain of a sub-virtual object, other than the corresponding sub-virtual object in within the plurality of sub-virtual objects;
determining at least one target geometric area in the path finding map based on the plurality of reference lines; and
splicing the plurality of sub-virtual objects according to the at least one target geometric area corresponding to each sub-virtual object to obtain a game scene, wherein the virtual game character finds a path on a terrain of the game scene.

2. The method according to claim 1, wherein determining the plurality of reference lines of the path finding map of the corresponding sub-virtual object comprises:
determining the plurality of reference lines based on a local coordinate system, wherein the path finding map is located in the local coordinate system.

3. The method according to claim 2, wherein determining the plurality of reference lines based on the local coordinate system comprises:
taking an origin of the coordinate system as a reference, determining a first reference line perpendicular to a first coordinate axis at intervals of a target size along the first coordinate axis of the coordinate system, and
determining a second reference line perpendicular to a second coordinate axis at intervals of the target size along the second coordinate axis of the coordinate system, wherein the first coordinate axis is perpendicular to the second coordinate axis.

4. The method according to claim 3, wherein the target size is negatively correlated with an accuracy of splicing the plurality of sub-virtual objects.

5. The method according to claim 2, wherein the method further comprises:
determining an origin of the local coordinate system, wherein the terrain of the corresponding sub-virtual object is located as an origin of the local coordinate system.

6. The method according to claim 1, wherein determining the at least one target geometric area in the path finding map based on the plurality of reference lines comprises:
dividing the path finding map into a plurality of square areas based on the plurality of reference lines; and
determining at least one target square area in the plurality of square areas, wherein the at least one target geometric area comprises the at least one target square area.

7. The method according to claim 6, wherein determining the at least one target square area in the plurality of square areas comprises:
determining at least one square area located at an edge position of the corresponding sub-virtual object in the plurality of square areas as the at least one target square area.

8. The method according to claim 1, wherein the splicing the plurality of sub-virtual objects according to the at least one target geometric area corresponding to each sub-virtual object to obtain the game scene comprises:
overlapping, based on an association relationship between a first sub-virtual object and a second sub-virtual object, the at least one target geometric area in the path finding map of the first sub-virtual object with the at least one target geometric area in the path finding map of the second sub-virtual object to obtain the game scene, wherein the first sub-virtual object and the second sub-virtual object are each selected from the plurality of sub-virtual objects, and the association relationship is configured for indicating that the virtual game character is allowed to find a path between a terrain of the first sub-virtual object and a terrain of the second sub-virtual object.

9. The method according to claim 8, wherein overlapping the at least one target geometric area in the path finding map of the first sub-virtual object with the at least one target geometric area in the path finding map of the second sub-virtual object to obtain the game scene comprises:
determining at least one first sub-path finding map on the at least one target geometric area in the path finding map of the first sub-virtual object;
determining at least one second sub-path finding map on the at least one target geometric area in the path finding map of the second sub-virtual object;
overlapping the at least one first sub-path finding map and the at least one second sub-path finding map to obtain a target path finding map, wherein the target path finding map is located within an area defined by the plurality of reference lines; and
generating the game scene based on the target path finding map.

10. The method according to claim 8, wherein the method further comprises:
determining, based on a first current orientation in a world space of the at least one target geometric area in the path finding map of the first sub-virtual object and a second current orientation in the world space of the at least one target geometric area in the path finding map of the second sub-virtual object, orientation adjustment information of the second sub-virtual object in the world space, wherein the first current orientation and the second current orientation are randomly determined orientations, and the orientation adjustment information is configured for representing information for adjusting at least one of a position of the second sub-virtual object in the world space or a direction of the second sub-virtual object in the world space; and
adjusting a current orientation of the second sub-virtual object in the world space based on the orientation adjustment information, enabling the at least one target geometric area in the path finding map of the first sub-virtual object is overlapped with the at least one target geometric area in the path finding map of the adjusted second sub-virtual object.

11. The method according to claim 8, wherein the method further comprises:
reading the first sub-virtual object, the second sub-virtual object, and the association relationship in a configuration relationship table, wherein the configuration relationship table comprises identifiers of the plurality of sub-virtual objects, and comprises an association relationship between every two sub-virtual objects in the plurality of sub-virtual objects, and the association relationship between every two sub-virtual objects is configured for indicating that the virtual game character is allowed to find a path between terrains of the every two sub-virtual objects.

12. The method according to claim 1, wherein acquiring the path finding maps of the plurality of sub-virtual objects comprises:
generating path finding resources of each sub-virtual object based on the terrain resources of each sub-virtual object; and
generating the path finding maps for each sub-virtual object based on the path finding resources of each sub-virtual object, wherein the path finding maps comprise polygonal patches of each sub-virtual object.

13. (canceled)

14. One or more non-transitory computer-readable storage media containing, in any combination, computer program code that, when executed by a computer system, perform an operation comprising:
acquiring path finding maps of a plurality of sub-virtual objects, wherein a path finding map is configured for guiding a virtual game character to find a path on a terrain of a corresponding sub-virtual object;
determining a plurality of reference lines of the path finding map of the corresponding sub-virtual object, wherein the plurality of reference lines are configured for enabling the virtual game character to find a path from the terrain of the corresponding sub-virtual object to a terrain of a sub-virtual object, other than the corresponding sub-virtual object within the plurality of sub-virtual objects;
determining at least one target geometric area in the path finding map based on the plurality of reference lines; and
splicing the plurality of sub-virtual objects according to the at least one target geometric area corresponding to each sub-virtual object to obtain a game scene, wherein the virtual game character finds a path on a terrain of the game scene.

15. A system, comprising:
one or more memories collectively containing one or more programs; and
one or more processors, wherein the one or more processors are configured to, individually or collectively, perform an operation comprising:
acquiring path finding maps of a plurality of sub-virtual objects, wherein a path finding map is configured for guiding a virtual game character to find a path on a terrain of a corresponding sub-virtual object;
determining a plurality of reference lines of the path finding map of the corresponding sub-virtual object, wherein the plurality of reference lines are configured for enabling the virtual game character to find a path from the terrain of the corresponding sub-virtual object to a terrain of a sub-virtual object, other than the corresponding sub-virtual object within the plurality of sub-virtual objects;
determining at least one target geometric area in the path finding map based on the plurality of reference lines; and
splicing the plurality of sub-virtual objects according to the at least one target geometric area corresponding to each sub-virtual object to obtain a game scene, wherein the virtual game character finds a path on a terrain of the game scene.

16. The system according to claim 15, wherein determining the plurality of reference lines of the path finding map of the corresponding sub-virtual object comprises:
determining the plurality of reference lines based on a local coordinate system, wherein the path finding map is located in the local coordinate system.

17. The system according to claim 16, wherein determining the plurality of reference lines based on the local coordinate system comprises:
taking an origin of the coordinate system as a reference, determining a first reference line perpendicular to a first coordinate axis at intervals of a target size along the first coordinate axis of the coordinate system, and
determining a second reference line perpendicular to a second coordinate axis at intervals of the target size along the second coordinate axis of the coordinate system, wherein the first coordinate axis is perpendicular to the second coordinate axis.

18. The system according to claim 17, wherein the target size is negatively correlated with an accuracy of splicing the plurality of sub-virtual objects.

19. The system according to claim 16, wherein the method further comprises:
determining an origin of the local coordinate system, wherein the terrain of the corresponding sub-virtual object is located as an origin of the local coordinate system.

20. The system according to claim 15, wherein determining the at least one target geometric area in the path finding map based on the plurality of reference lines comprises:
dividing the path finding map into a plurality of square areas based on the plurality of reference lines; and
determining at least one target square area in the plurality of square areas, wherein the at least one target geometric area comprises the at least one target square area.

21. The system according to claim 15, wherein splicing the plurality of sub-virtual objects according to the at least one target geometric area corresponding to each sub-virtual object to obtain the game scene comprises:
overlapping, based on an association relationship between a first sub-virtual object and a second sub-virtual object, the at least one target geometric area in the path finding map of the first sub-virtual object with the at least one target geometric area in the path finding map of the second sub-virtual object to obtain the game scene, wherein the first sub-virtual object and the second sub-virtual object are each selected from the plurality of sub-virtual objects, and the association relationship is configured for indicating that the virtual game character is allowed to find a path between a terrain of the first sub-virtual object and a terrain of the second sub-virtual object.
